(19) United States
(12) Patent Application Publication
(10) Pub. No.: US 2014/0289009 A1
(43) Pub. Date: Sep. 25, 2014

(54) METHODS, SYSTEMS AND COMPUTER READABLE MEDIA FOR MAXIMIZING SALES IN A RETAIL ENVIRONMENT

(71) Applicant: Triangle Strategy Group, LLC, Raleigh, NC (US)

(72) Inventor: Patrick Joseph Campbell, Raleigh, NC (US)

(73) Assignee: Triangle Strategy Group, LLC, Raleigh, NC (US)

(21) Appl. No.: 14/215,933

(22) Filed: Mar. 17, 2014

Related U.S. Application Data
(60) Provisional application No. 61/852,354, filed on Mar. 15, 2013.

(51) Int. Cl. G06Q 30/02

(52) U.S. Cl. CPC G06Q 30/0201; G06Q 30/0202
USPC 705/7.31; 705/7.29

(57) ABSTRACT

Methods, systems and computer program products for maximizing sales in a retail environment are disclosed. Information is measured regarding drivers of shopper in-store behavior and its underlying drivers of ergonomics, visibility and desirability. Models are fitted and used to optimize sales. Outputs include new merchandising display arrangements, planograms and marketing plans.

### PRIORITY CLAIM

This application claims the benefit of U.S. Provisional Patent Application No. 61/852,354 filed Mar. 15, 2013, the disclosure of which is incorporated herein by reference in its entirety.

### TECHNICAL FIELD

The subject matter described herein relates to methods, systems and computer readable media for maximizing sales in a retail environment. More particularly, the present invention relates to methods, systems and computer program products for experimental investigation of the root causes of shopper behavior leading up to purchase. The methods include planning of in-store experiments, execution of those experiments, quality control of experimental data, data cleaning, fitting of models to that data, simulation of scenarios using those models and optimization of variables in those models to maximize sales. The models explicitly separate out traffic from conversion and breaks out conversion into its components of ergonomics, visibility, desirability and their underlying drivers.

### BACKGROUND

Marketers have been searching for effective methods for optimizing productivity of merchandising space for almost 100 years since the opening of the first self-service grocery store in 1916. The advantages of effective productivity optimization methods are many—a recent study estimated that if space could be optimized in some parts of the store, sales would grow by as much as 30%. Because of this there is significant business utility to having reliable quantitative tools that allow optimization of retail space.

Several quantitative approaches to store space optimization have been attempted. The most common approached focus on consumer desirability of individual Stock Keeping Units (hereafter SKUs) and rely on analyses of sales velocity and sales interactions between SKUs. It is a popular theme among shopper marketers (and our work supports) that that two key physical factors—ergonomics and visibility—also critically drive sales. In this context, ergonomics is the fraction of shoppers coming within sufficient physical distance of a product to consider a purchase, visibility is the fraction of those shoppers who then subsequently see the product and desirability is the fraction of those shoppers who subsequently buy it. In some cases ergonomics and visibility effects are more important drivers of purchase than desirability effects. However in the prior quantitative modeling work the importance of ergonomics and visibility drivers has been conspicuously overlooked. What is needed therefore is a complete model of shopper purchase behavior that takes into account the quantitative impact of ergonomics and visibility in addition to desirability. One reason for the lack of emphasis on ergonomics and visibility in prior modeling work is simply a lack of accurate and effective methods for measuring these factors in a retail environment.

What is therefore needed is a method for directly and cost effectively measuring ergonomics and visibility in a retail environment.

Eye tracking has been used to understand visibility. However, conventional eye tracking requires shopper to wear measurement hardware, thus biasing the results. Also often the shopper is asked to stand in an unnatural position, further biasing the results. Finally eye tracking is costly due to the logistics of recruiting shoppers to enroll in an eye tracking study and administering the study which typically limits sample size and duration. What is needed therefore is a method to measure shopper visibility without interfering with the shopper's natural shopping process.

Past sales modeling approaches have generally attempted to explain sales effects at a store or chain level.

However the factors of ergonomics and visibility vary considerably between and within stores—to be assessed accurately these factors must be analyzed at individual merchandising locations.

What is further needed therefore is a methodology to measure and predict sales performance at individual merchandising locations and further model these effects with sufficient sophistication to allow extrapolation to other locations.

In conventional merchandizing analytics, a frequent complaint is the costs and long duration of tests required to perform sufficient experimentation to fully develop models that accurately separate ergonomics from visibility and desirability. What is further needed therefore is the ability to drive a fast, accurate, cost effective experimental program.

A major driver of test duration is the need to overcome variability in sales data driven by variation in shopper traffic.

What is further needed there therefore is the ability to net out the impact of shopper traffic.

### SUMMARY

It is therefore objects of the subject matter described herein to:

measure and model the impact of ergonomics and visibility directly from shopper measurement and/or observation at individual points of sale without distracting the shopper;

model these effects with sufficient depth of root cause decomposition to allow extrapolation of learnings to other locations with different arrangements; and

measure conversion, rather than just sales, thus eliminating the effect of shopper traffic and keep test cycle time and costs to a minimum, so enabling a significant number of test cells.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

FIG. 1 is a block diagram of a system for maximizing sales in a retail environment according to an embodiment of the subject matter described herein;

FIG. 2 is a flow chart of a process for maximizing sales in a retail environment according to an embodiment of the subject matter described herein;

FIG. 3 is a flow chart of a process for predicting shopper conversion according to an embodiment of the subject matter described herein;

FIG. 4 is a flow chart illustrating factors for predicting shopper conversion according to an embodiment of the subject matter described herein;

FIG. 5 is a perspective view illustrating shopper position relative to a retail location;

FIG. 6 is a schematic diagram of a system for measuring shopper position relative to a retail location according to an embodiment of the subject matter described herein;

FIG. 7 illustrates graphs of conversion factors with respect to shopper position according to an embodiment of the subject matter described herein;

FIG. 8 is a graph of a vertical conversion factor with respect to display height according to an embodiment of the subject matter described herein;

FIG. 9 is a graph of a separation factor versus separation distance according to an embodiment of the subject matter described herein;

FIG. 10 includes a graph and a heat map of an ergonomics factor versus shopper position according to an embodiment of the subject matter described herein;

FIG. 11 includes graphs of a display size factor versus display size according to an embodiment of the subject matter described herein;

FIG. 12 a graph of a signage factor for different signage types according to an embodiment of the subject matter described herein;

FIG. 13 is a graph of a display activation factor versus different display activation methods according to an embodiment of the subject matter described herein;

FIGS. 14a and 14b are graphs illustrating vertical and horizontal exposure factors for different viewing angles according to an embodiment of the subject matter described herein;

FIG. 15 is a graph of a stock factor for different stock levels according to an embodiment of the subject matter described herein;

FIG. 16 a graph of a wait time factor versus weight time according to an embodiment of the subject matter described herein;

FIG. 17 illustrates heat maps combining proximity and visibility effects on conversion according to an embodiment of the subject matter described herein;

FIG. 18 is a graph of a container design factor for various container designs according to an embodiment of the subject matter described herein;

FIG. 19 illustrates graphs of an adjacency factor according to an embodiment of the subject matter described herein;

FIG. 20 is a graph of a pricing factor according to an embodiment of the subject matter described herein;

FIG. 21 is graph of a salesperson interaction factor for different salesperson interactions and different products according to an embodiment of the subject matter described herein;

FIG. 22 is a graph of a shopper cue factor versus time according to an embodiment of the subject matter described herein;

FIG. 23 is a graph of a shopper-graphics factor according to an embodiment of the subject matter described herein;

FIG. 24 is graph of a shopper mission factor according to an embodiment of the subject matter described herein;

FIG. 25 is flow chart illustrating an exemplary process for planning a set of test cells according to an embodiment of the subject matter described herein;

FIG. 26 is flow chart and a graph illustrating a process for measuring a conversion factor for different display activations and measurements of the conversion factor according to an embodiment of the subject matter described herein;

FIG. 27 includes flow charts of processes for measuring convergences of a test cell according to an embodiment of the subject matter described herein;

FIG. 28 is a flow chart of a process for logging data collected by a system for maximizing sales in a retail environment according to an embodiment of the subject matter described herein;

FIG. 29 is a flow chart illustrating a process for cleaning data collected by a system for maximizing sales in a retail environment according to an embodiment of the subject matter described herein;

FIG. 30 is a flow chart illustrating a process for model fitting performed by a system for maximizing sales in a retail environment according to an embodiment of the subject matter described herein; and

FIG. 31 is block diagram illustrating a specification for a graphical user interface of a system for maximizing sales in a retail environment according to an embodiment of the subject matter described herein.

### DETAILED DESCRIPTION

The subject matter described herein may be implemented as a set of programs, measurement systems, control parameters, parametric models, model fitting programs, optimization tools and planning tools. The subject matter described herein includes a predictive model which explicitly models the progression of shoppers through a set of conditions we will refer to as “traffic”, “ergonomics”, “visibility”, “desirability” and ultimately “conversion”.

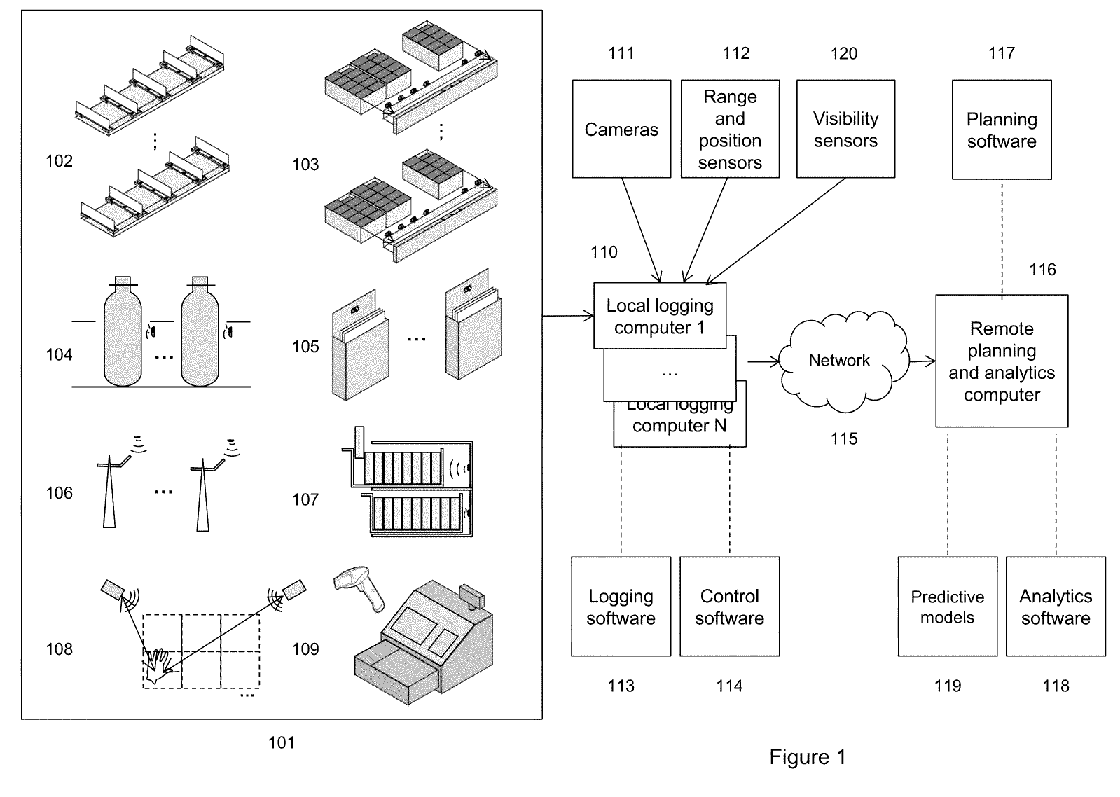

The methods and systems described herein for maximizing sales in a retail environment may be implemented as a hardware and software system on one or more computers and a set of models, programs and algorithms on one or more computers for measuring shopper behaviors of interest either directly or through proxy variables. FIG. 1 illustrates an exemplary operating environment for the sales maximization system according to an embodiment of the subject matter described herein. Referring to FIG. 1, a set of pickup sensors tracks individual shopper interactions with product within a defined merchandising area. Sensors may include but are not limited to:

weight sensors 102 customized to track items stored in a carton as described in U.S. patent application publication number 2012/0245969 (hereinafter, “the '969 Publication”), the disclosure of which is incorporated herein by reference in its entirety;

optical sensors 103 customized to track items stored in a carton as described in U.S. provisional patent application No. 61/748,352 (hereinafter, “the '352 application”), the disclosure of which is incorporated herein by reference in its entirety;

optical sensors 104 customized to track removal of bottle items as described in the '352 application;

optical sensors 105 customized to track removal of vertically merchandised items such as magazines, newspapers, phone cards, leaflets as described in the '352 application;

optical sensors 106 customized to track removal of items merchandised on peg hooks as described in the '352 application;

optical sensors 107 customized to track removal of items merchandised in drawers as described in the '352 application;

position sensors 108 tracking passage of a shopper's hand and items through a plane in space as described in the '969 Publication; and

cameras that track removal of items as described in the '969 Publication.

Checkout transaction log data 109 may be used as a proxy for actual pickup data, although this limits utility to items with a single merchandising location and a single checkout and does not provide time series data on the sequence of actions that led to purchase. A set of local logging computers 110 may log pickup data from the pickup sensors. A set of cameras 111 may track shoppers and conditions within the merchandising area. A set of range and position sensors 112 may track the proximity and motion paths of shoppers in relation to the merchandising area. Suitable sensors include ultrasonic range sensors, infra-red range finders and 3D cameras.

Visibility sensors 120 may track the direction and movement of shoppers' eyes. Suitable sensors include gaze trackers mounted in a fixed location in the store, portable eye trackers worn by shoppers or 3D cameras.

Logging module 113 may include programs and algorithms for experiment setup and validation, data logging, and data quality control. Control software 114 may control in store activation activities, for example illumination of the product display, media or audio. A network 115 may connect one or more local logging computers to a remote analytics and planning computer 116. Remote computer 116 may execute predictive and analytics module 118, which may perform one or more of:

experimental planning;

determination of successful test cell completion/need for continuation;

data cleaning;

model fitting;

reporting of model results and confidence parameters;

simulating scenarios using the fitted model; and

optimizing scenarios using the simulator capable by optimizing one or more input variables.

Predictive models 119 may model the effect of one or more measured input variables on one or more measures of shopper behavior.

The aforementioned items may be implemented either automatically or manually.

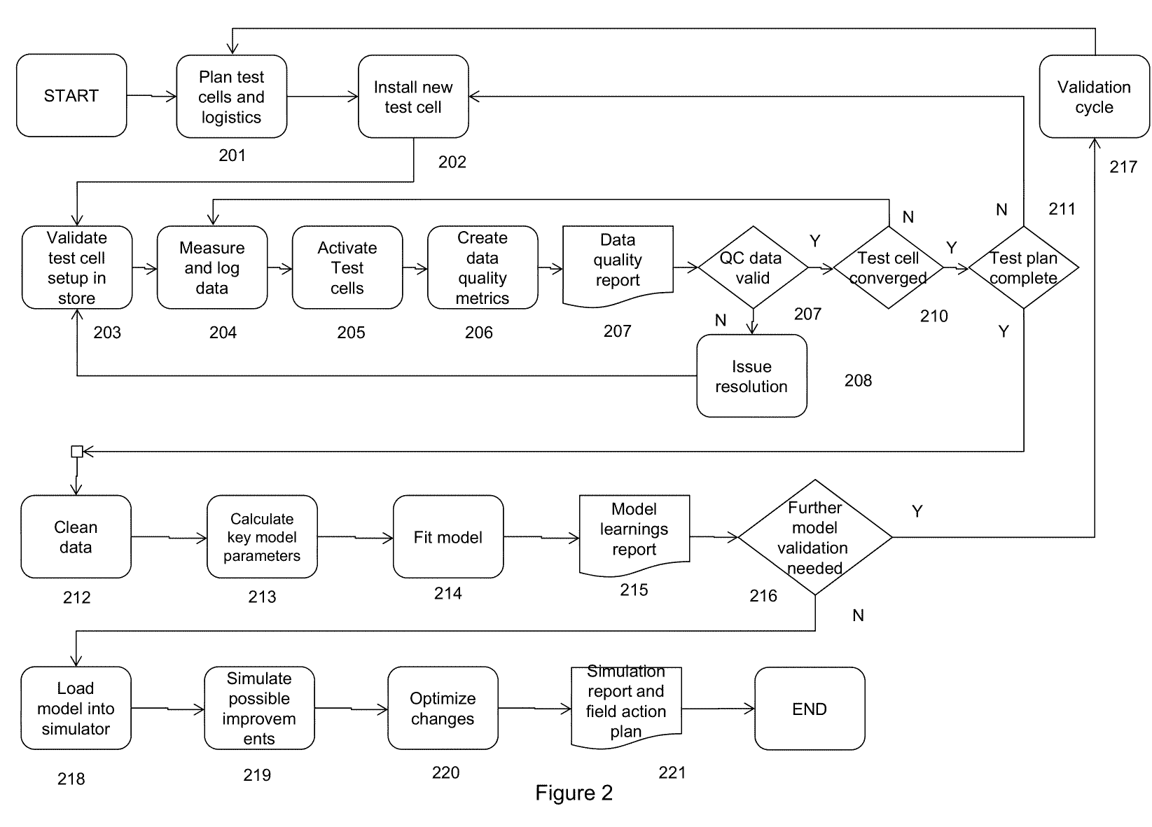

FIG. 2 illustrates a typical mode of operation of the sales maximization system operations in one embodiment of the subject matter described herein. Referring to FIG. 2, a user applies a planning algorithm 201 to identify, design and plan a number of test cells to evaluate the impact of a set of experimental variables of interest designated by the user. In one embodiment, planning algorithm 201 may include an expert system to assist the user in making choices. Test cells are installed 202 in one or more stores store and validated 203 for proper installation and proper operation of all functions of logging systems. In-store data, including but not limited to pickups, motion, visibility and camera data, is measured and logged 204. Any activation features required by the current test cell (such as changing level of illumination of display) are activated 205.

Periodically (preferably on at least a daily basis), data quality metrics are calculated 206 and a data quality report 207 is produced. Data quality is evaluated 208 against prescribed criteria and if unacceptable an issue resolution procedure 209 is invoked. If the current test cell has not converged 210, then logging is resumed 204. If the current test cell has converged 210, and if the full test plan has not yet been completed 211, then the next test cell in the testing plan is installed 202.

If the full test plan has completed 211, then data cleaning 212 is executed. Key model parameters 213 are then calculated, including the full set of independent and dependent variables necessary for model fitting. Model fitting is carried out 214 and a model learning report 215 is created, including an assessment of whether the model satisfactorily explains the measured data.

If the model does not satisfactorily explain the measured data 216 then a model validation procedure 217 is invoked which will typically result in one of more of the following actions:

further time/number of repeats on current test cells;

exclusion of outliers; and

new testing plan to define drivers of idiosyncratic learnings;

If the model does satisfactorily explain the measured data then model parameters are loaded into a simulator 218. The user applies the simulator to simulate a set of possible improvement scenarios 219. Optionally, the user may apply an automated optimization routine 220 to optimize variables within scenarios. A simulation report and field action plan are produced 221, after which the process terminates.

One feature of the subject matter described herein includes a factor model which predicts shopper conversion of a specific SKU.

The model is constructed in multiplicative form, however other model forms are possible and will be apparent to those skilled in the art. The multiplicative model incorporates a number of effects through multiplicative factors which relate to underlying physical conditions in a store and marketing choices as described below.

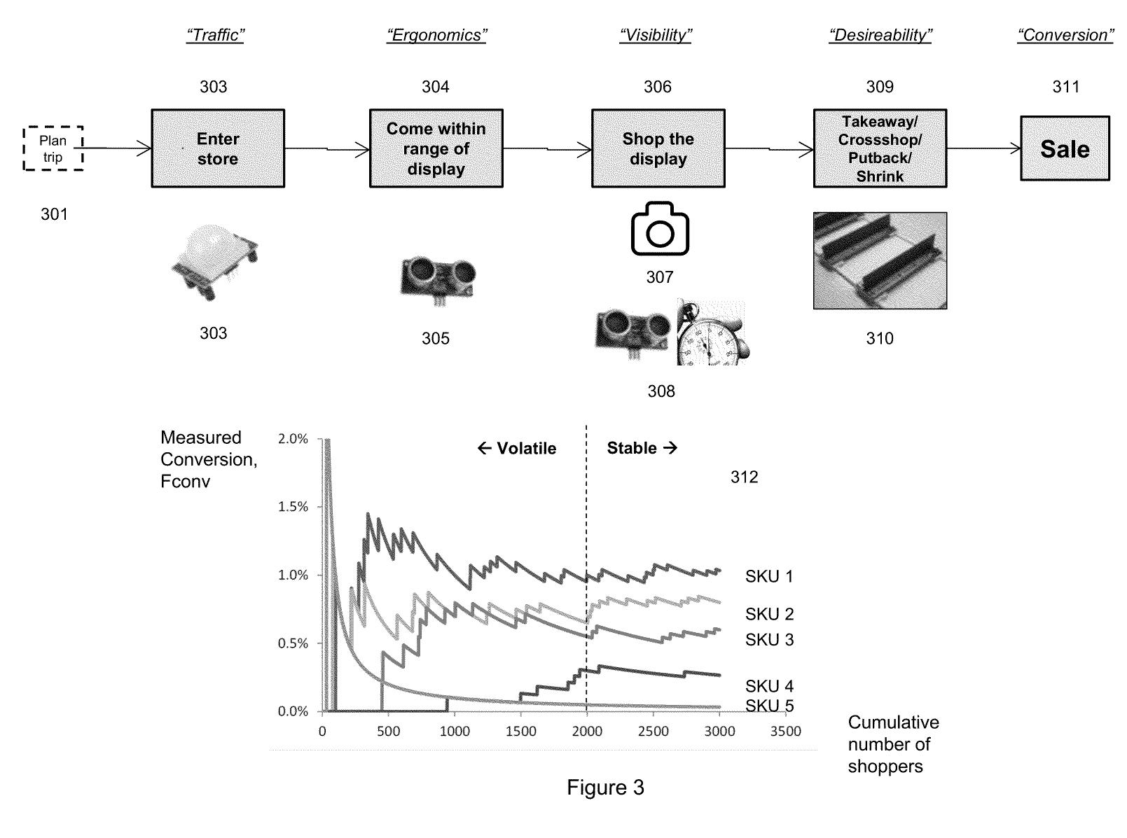

As illustrated in FIG. 3 the model explicitly models the progression of shoppers through a set of conditions/states “traffic”, “ergonomics”, “visibility”, “desirability” and ultimately “conversion”. As used herein the terms:

“Traffic” 303 refers to the number of shoppers entering a retail location and is measurable with a motion sensor such as a passive infrared sensor 303;

“Ergonomics” 304 refers to the fraction of those shoppers coming within a predetermined proximity to a SKU for a predetermined period of time and is measurable with a proximity sensor such as an ultrasonic range sensor 305;

“Visibility” 306 refers to the fraction of those shoppers shopping the display. In one embodiment this may be measurable directly by gaze tracking with a camera system 307. In further embodiments this may be measured directly using eye tracking hardware worn by a shopper, or using a 3D camera. In a further embodiment, visibility may be proxied by the extent to which a shopper pauses within a configurable range of the display for at least a configurable period of time. The proxy approach is generally lower cost and more accurate, less labor intensive, and less intrusive, requiring simple range sensors and time measurement, rather than gaze tracking or eye tracking which requires camera equipment, gaze tracking software and some degree of post event review of photographs, notwithstanding privacy and consent issues of using conspicuous cameras);

“Desirability” 309 refers to the fraction of visibility events resulting in a shopper taking a product away from the retail display and may be measured with a pickup sensor 310 for which there are many options 101;

“Conversion” 311 refers to the final proportion of shoppers who entered the location who purchased a product and mathematically is the product of ergonomics×visibility×desirability.

One feature of the sales maximization system is the ability to drive test cells to converged results quickly so as to enable cost effective evaluation of the impact of a broad cross section of drivers. Sales are affected by large fluctuations in shopper traffic on a daily and weekly basis—working just with sales data, estimation of the effect of improvements requires long periods of time and controls to average out the effect of traffic differences.

By calculating conversion however, as is done in the sales maximization system, the effect of shopper traffic is netted out of sales. As shown 312, meaningful convergence can be achieved in a few as 2000 shoppers, which in our practical experience translates to a week or less of measurement in most viable retail locations.

In contrast, testing without taking shopper traffic into account typically requires 2-3 months of testing to produce a result—and so the sales maximization system is able to realize a factor of ˜10 increase in speed.

The form of the multiplicative model is:

F_{conv}=F_{erg}×Fᵥᵢₛ×F_{des}

### Where:

F_{conv}=shopper conversion, the fraction of shoppers purchasing an individual product;
F_{erg}=ergonomics factor, reflecting the impact of physical placement of display;
Fᵥᵢₛ=visibility factor, reflecting the impact of display design and physical conditions;
F_{des}=desirability factor, reflecting the impact of attributes of the specific SKU.

By multiplying factors as described it is possible to produce a conversion metric for:

each item on the display;

the display overall; or

subsets of the display (e.g. one shelf).

As will be described, some factors are dependent on the item, some on the item's location, some on aspects of design and some on marketing choices. F_{erg}, Fᵥᵢₛ, F_{des} are influenced by a number of underlying conditions, arrangements and choices. The current invention explicitly models these effects.

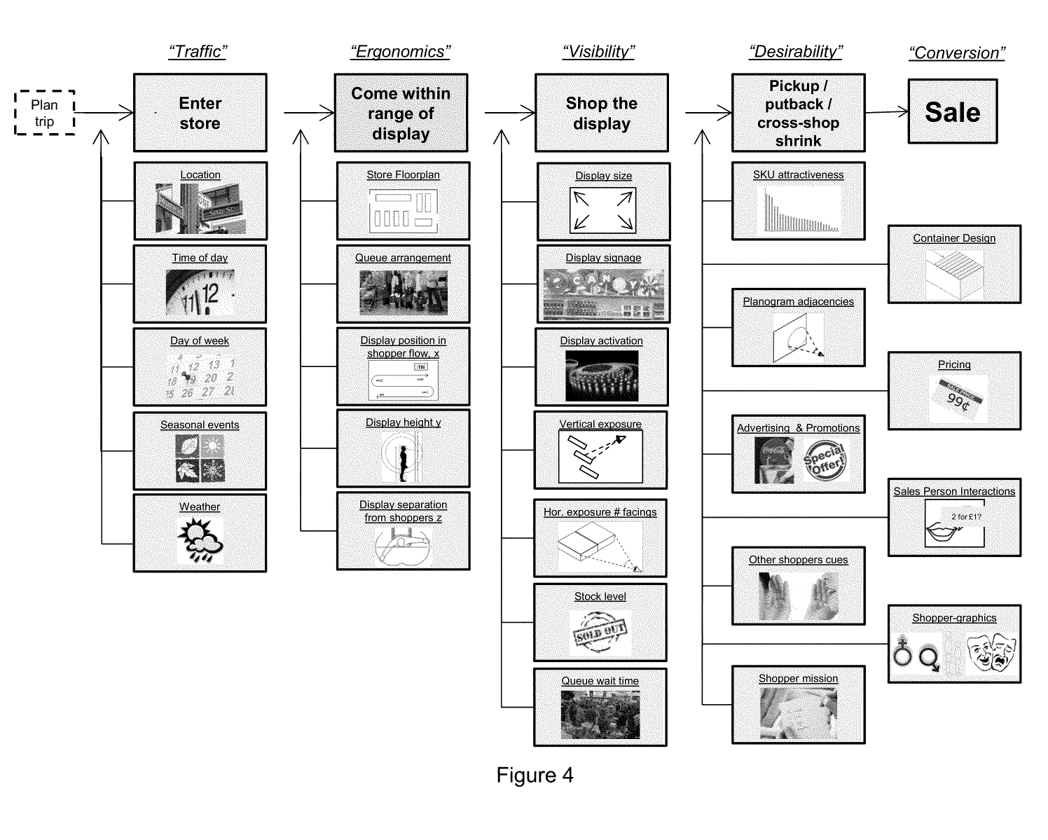

FIG. 4 illustrates one embodiment of the model where the information used to model the conditions may include:

physical attributes internal to the retail location such as floorplan, queuing arrangements;

physical attributes of product merchandising and display design features; physical attributes of product, such as design, graphics, container design;

shopper attributes such as “mission”—the purpose of a shoppers trip;

“shopper-graphics” including gender, ethnicity, age, mood, attire and physical parameters such as height, weight;

retailer choices such as range of products displayed, pricing;

dynamic conditions such as queue length, other shoppers' behavior;

retailer behavior such as sales person actions, incentives, scripts, till point conversations; or

actions by manufacturers/retailers such as advertising and promotions

In other embodiments the model can further explore the drivers of traffic, which typically include:

environmental metrics such as weather, time of day, week, year; and

external factors such as location, proximity to other locations, characteristics of surrounding shopper population;

Ergonomics factor, F_{erg} is an index quantifying the relative value of the position of a merchandising location on shopper conversion. F_{erg} is driven by the physical location of the merchandising location relative to a shopper and the shopper's comfortable range of vision and reach.

Most precisely, F_{erg} is the fraction of shoppers whose fields of view and reach comes within a minimum range of a merchandising location for a minimum period of time.

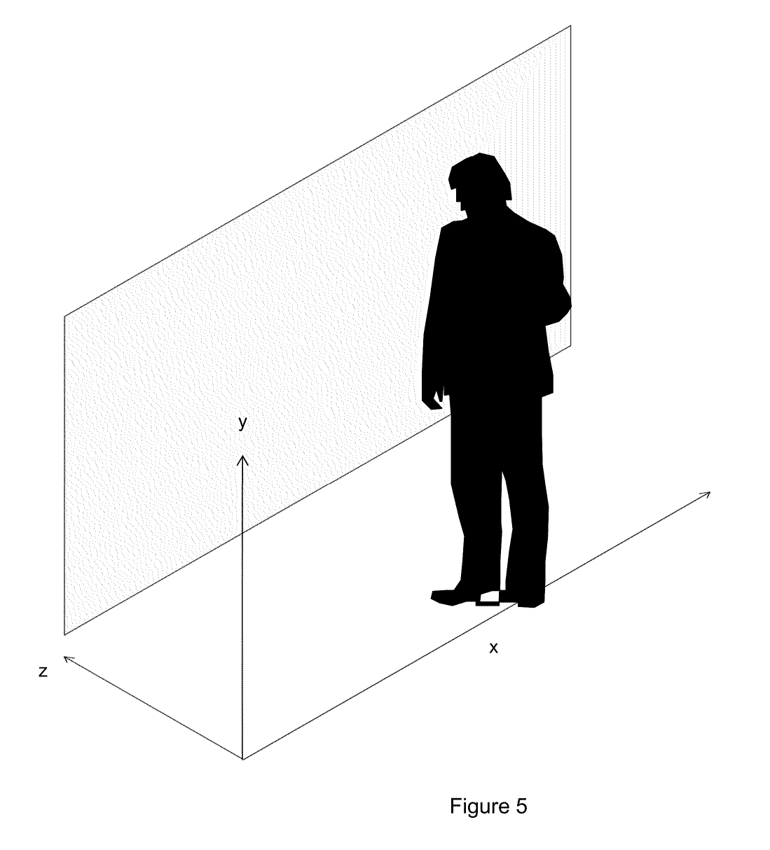

A merchandising location can refer to any location on a merchandising display, characterized by three coordinates x, the horizontal position relative to a prevailing shopper traffic flow, y, the vertical clearance from ground and z, the separation of the location from the shopper. An example is shown in FIG. 5.

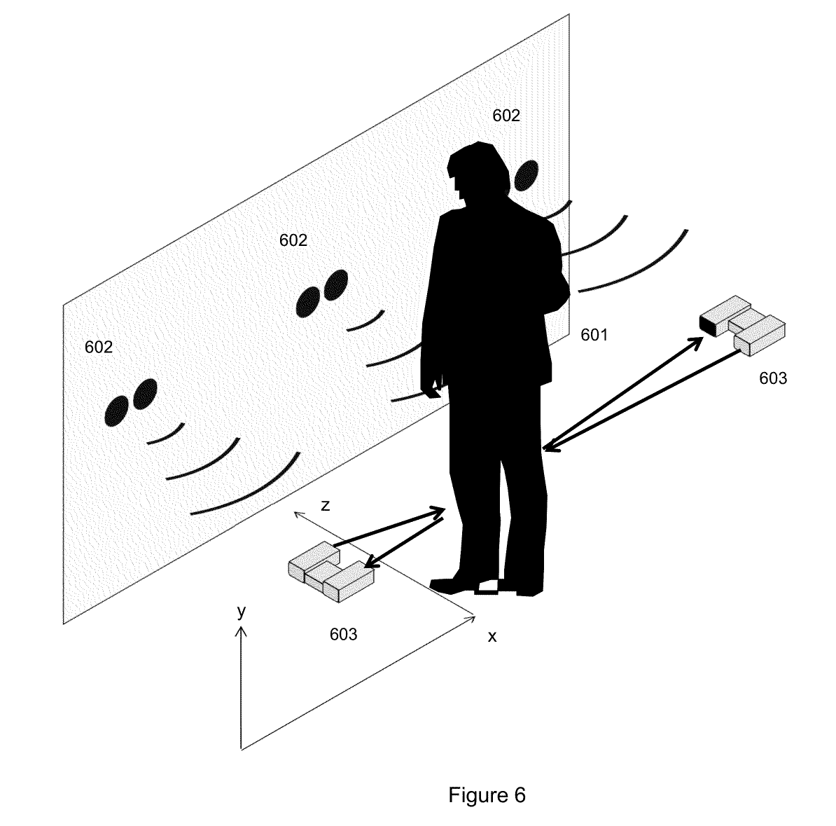

Accurate modeling of F_{erg} requires the ability to accurately detect a shopper's position in the x and z directions. As shown in FIG. 6:

the x position of a shopper 601 may be exactly measured using one or more range sensors 603 positioned so as to detect shopper's location; and

the z position of a shopper 601 may be exactly measured using one or more range sensors 602 positioned so as to detect shopper's location.

Ultrasonic and infrared sensors are well suited to these position sensing applications.

F_{erg}, may be constructed as:

a lookup array with an entry for each combination of x, y and z; or

decomposed to sub-factors Fₓ, F_{y}, and F_{z} as follows:

F_{erg}=Fₓ×F_{y}×F_{z}

### Where

Fₓ=horizontal factor
F_{y}=vertical factor
F_{z}=separation factor

Horizontal factor, Fₓ, is an index quantifying the impact of horizontal position x of a merchandising location relative to shopper traffic flow. In our practical experience, we have found Fₓ is a function of the amount of time the shopper population spends within a predetermined proximity of x. Different store layouts and queuing arrangements have substantially different profiles for Fₓ.

Fₓ may be constructed as:

an array with an entry for each level of x;

a fitted equation as a function of x; or

a fitted equation as a function of Fₜ.

### Where:

Fₜ=the fraction of shoppers remaining within a predetermined distance X_{reach} of a horizontal position x in shopper traffic flow for a duration greater than a minimum shoppable amount of time Tₛₕₒₚ.

### Where

X_{reach} is the comfortable reach of the average shopper, typically less than 1 meter, determined by average arm length (for an adult typically about 1 meter or 39 inches) and average comfortable reading distance, typically 50 cm or 20 inches.
Tₛₕₒₚ=is the absolute minimum time required to shop the merchandising unit, a fittable parameter and typically ˜2 seconds

Factor Fₓ may be typically generated by:

measuring changes in conversion of a specific product in response to moving the product to different horizontal positions, x on the merchandising fixture, while holding y, z and all other factors constant;

measuring changes in conversion of each product in response to moving the whole merchandising fixture to different positions in the x direction; or

cross referencing results from different locations with different merchandising fixture positions in the x direction but with all other factors the same or corrected for; or

measuring Fₜ and Fₓ in parallel and establishing a correlation. This correlation may be established either based on individual shopper events, or over a specified time window. This latter approach is preferred as it allows extrapolation to other scenarios for Fₜ by simply measuring Fₜ.

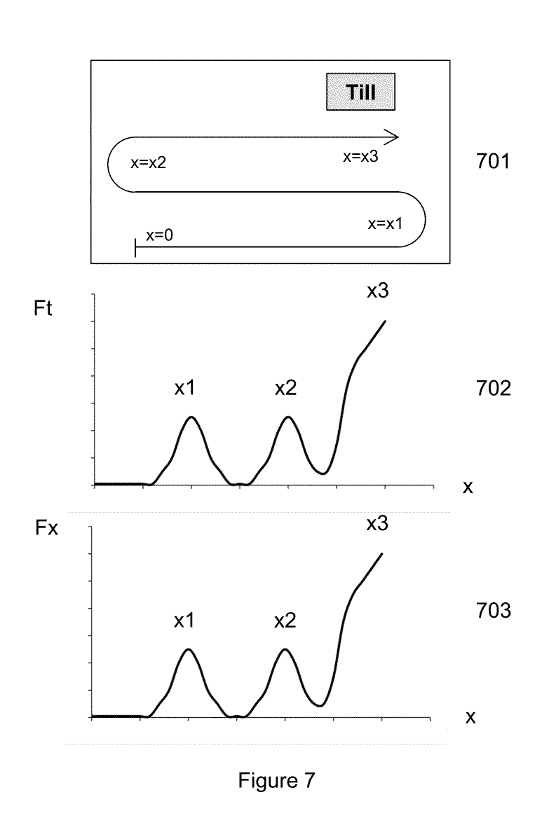

An example of the relationship of Fₓ to shopper traffic flow is shown in FIG. 7. The shopper's path through the store 701 results in an Fₜ profile 702—in this example the shopper spends more time in locations x₁ and x₂ and x₃. This Fₜ profile translates further to an Fₓ profile 703.

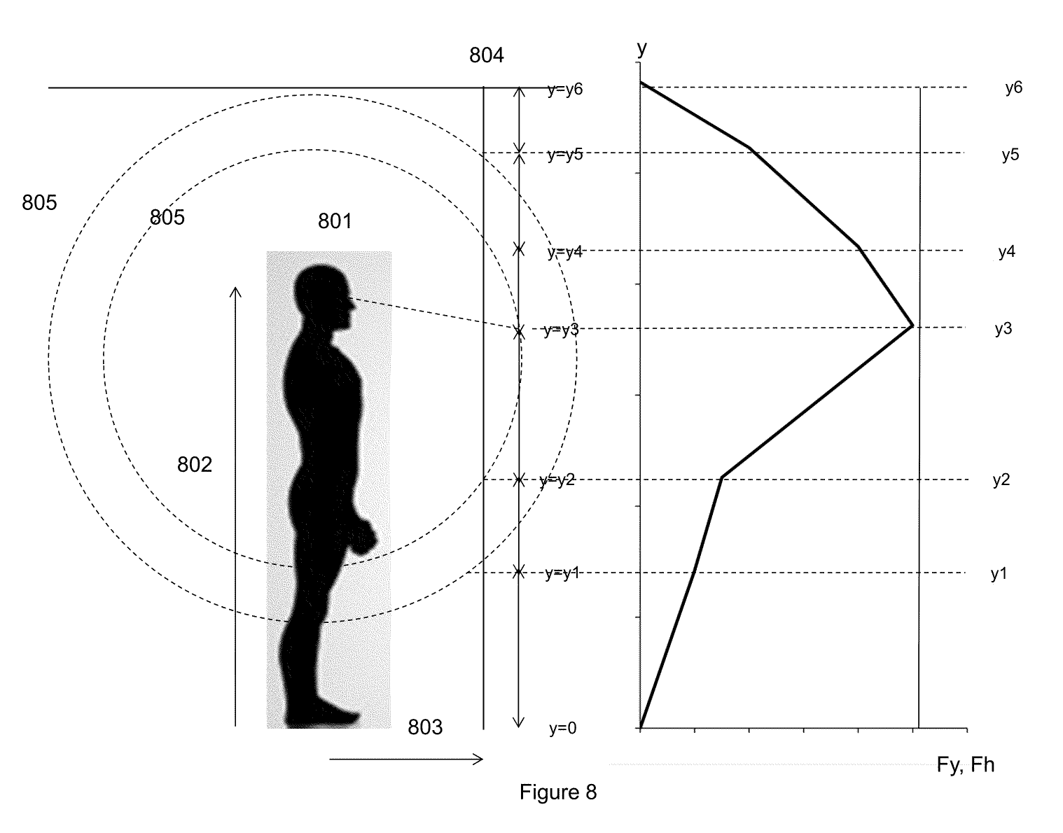

Vertical factor, F_{y}, is an index quantifying the impact of height of a merchandising location, y, from the ground and is related to shopper eye-level and field of view. An example of the typical relationship between F_{y} and y is shown in FIG. 8 which may include the following features:

the example shows a shopper 801 of average height 802 standing at a comfortable distance 803 from a merchandising display 804;

the shopper has comfortable reach 805 (achievable without rotating torso) and maximum reach 806 (achievable with rotating the torso and/or leaning);

F_{y} is highest at height y₃ corresponding to normal resting line of sight at 9 degrees down from horizontal;

Fₕ declines above this level up to y₄, corresponding to maximum comfortable reach and then faster to y₅ corresponding to maximum reach;

the shopper must then step closer to the stand to reach any items higher—F_{y} declines even faster until y₆ which represents the shopper's maximum vertical reach;

F_{y} declines with decreasing height below y₃ until y₂, corresponding to maximum comfortable reach and then at a different rate to y₁ corresponding to maximum reach without bending;

The shopper must then bend at the waist, squat and/or rotate the torso and/or lean to reach any items lower—F_{y} declines at a different rate faster until zero at the ground;

For modeling purposes F_{y} may be constructed as:

an array with an entry for each level of y;

a fitted equation as a function of y; or

a fitted equation as a function of Fₕ.

F_{y} may be typically generated by

measuring changes in conversion of a specific product in response to moving the product to different shelves on merchandising fixture, while holding x, z and all other drivers constant;

measuring changes in conversion of each product in response to moving the whole merchandising fixture up and down through a number of positions in the y direction; or

cross referencing results from different locations with different merchandising fixture heights but with all other factors the same or corrected for.

Further useful information informing the shape of Fy may be estimated by:

video observation of shopper events (both purchase and non-purchase); or

an ergonomics model derived from shopper dimensions and laboratory ergonomics studies.

Separation factor, F_{z}, is an index variable quantifying the impact of the distance shoppers are required to reach from their comfortable standing position to a specific merchandising location. In our practical experience, F_{z} is related to arm length, with maximum reach for a typical adult at 1 meter, but comfortable reach somewhat less than this, ˜80 cm.

z=separation of shopper from merchandising location and can be measured with a number of range and position sensors such as described in FIG. 6.

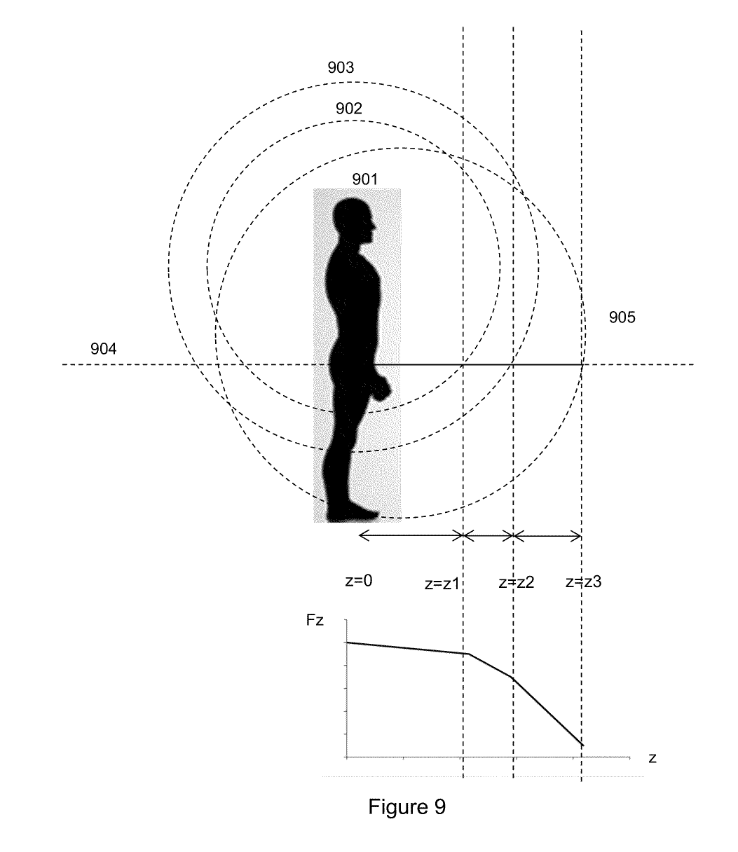

A typical profile for F_{z} is shown in FIG. 9:

the example shows a shopper 901 with comfortable reach 902 (achievable without rotating torso) and maximum reach 903 (achievable with rotating torso);

further by bending at the waist and/or rotating at the torso, shopper 901 has an extended reach of 905;

F_{z} is typically high and constant for z positions from 0 to z1, corresponding to maximum comfortable reach;

F_{z} declines somewhat up z₂, corresponding to maximum reach; and

F_{z} declines at a further faster rate from z₂, to zero at z₃ corresponding to extended reach.

For modeling purposes F_{z} may be constructed as:

an array with an entry for each z separation position (reflecting different degrees of separation for different positions on display); or

a fitted equation as a function of z reflecting reach.

For a given merchandising display design, z can vary as a function of =f(x,y), in particular for raked displays. F_{z} index can be typically generated:

by moving the whole merchandising unit back and forth, while holding x, y and all other drivers constant;

by moving parts of the display back and forth, while holding x, y and all other drivers constant; or

by measuring pickups for individual set of z measurements using real time data.

The form of F_{z} may be further informed by:

video observation of shopper events (both purchase and non-purchase); or

an ergonomics model derived from shopper dimensions and laboratory ergonomics studies.

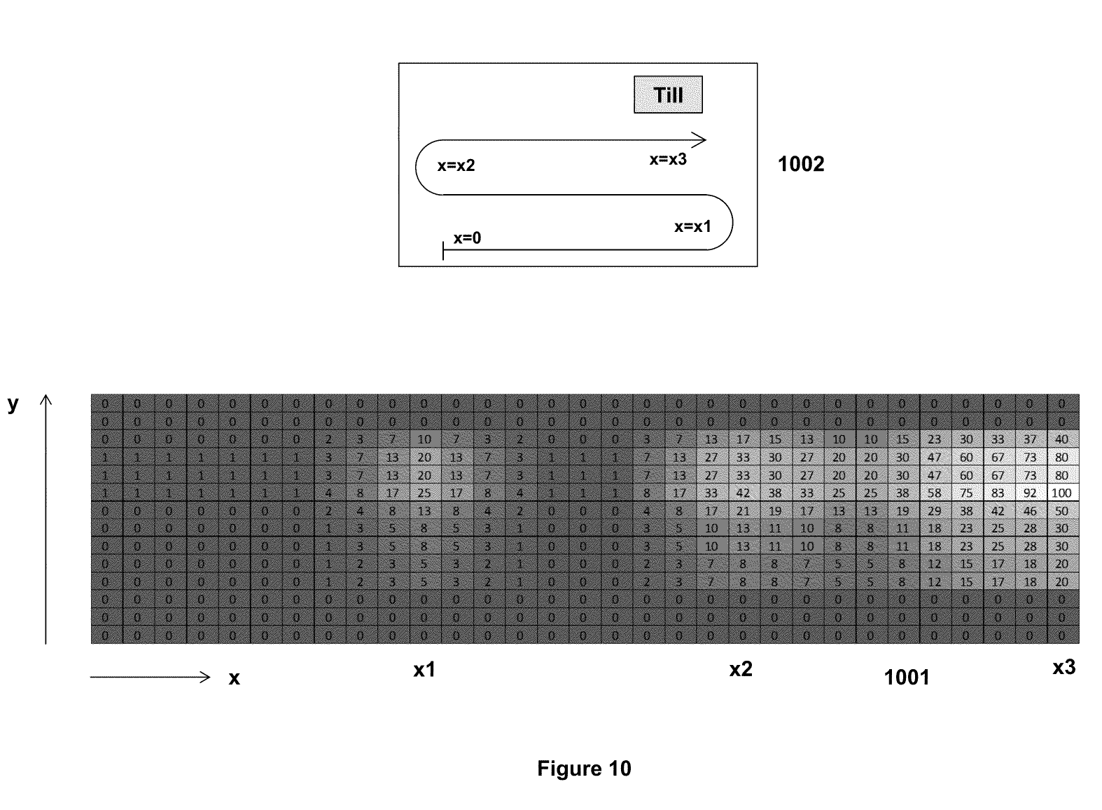

The overall profile of F_{erg} may be represented as an ergonomic heat-map as shown in FIG. 10. A heat-map 1001 shows how F_{erg} varies at different x and y positions along a shopper path 1002. More valuable locations are represented by warmer colors (red) and less valuable locations by cooler colors (blue). Heat-maps are of significant utility as a simple communications tool. As we shall see, this heat-map can be further modified for visibility effects. Visibility factor, Fᵥᵢₛ, is an index variable reflecting the impact on conversion of a shopper visually fixating on a display. A number of subcomponents affect the likelihood of this fixation. Some of these subcomponents affect the whole display whereas others particular locations on the display.

Fᵥᵢₛ may be measured:

directly using gaze tracking;

directly using eye tracking;

as a proxy the extent to which a shopper stands still or pauses within a configurable range of the display (the proxy approach is generally lower cost and more accurate, less labor intensive requiring simple range sensors, rather than post event review of photographs); or

from conversion data through a set of designed experiments.

Fᵥᵢₛ=F_{sz}×F_{sg}×F_{ac}×Fᵥₑₓ×Fₕₑₓ×Fₛₜ×F_{wt}

### Where

F_{sz}=size factor
F_{sg}=signage factor
F_{ac}=activation factor
Fᵥₑₓ=vertical exposure factor
Fₕₑₓ=horizontal exposure factor

Fₛₜ=stock-level factor

F_{wt}=wait-time factor

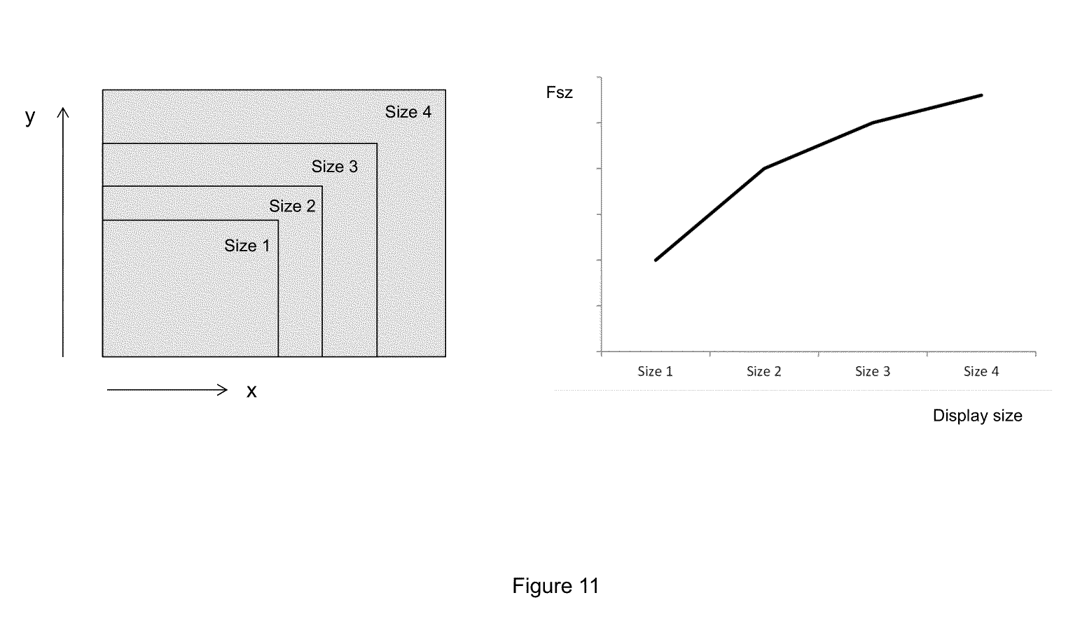

Size factor, F_{sz} is an index variable reflecting the impact of display size on visibility. A typical relationship of F_{sz} to size is shown in FIG. 11:

in our practical experience, the larger a display, the greater the likelihood of shoppers visually shopping the display;

however diminishing returns are achieved with increasing sizes reflecting saturation of the field of vision.

F_{sz} may be constructed as a single multiplier for the whole display. F_{sz} may be measured by testing different sizes of display in successive test cells (for example, adding an additional shelf) and measuring visibility Fᵥᵢₛ directly or conversion correcting for F_{eng} effect

Signage factor, F_{sg} is an index variable reflecting the impact of signage on visibility. Signage may incorporate ceiling signs, messaging on displays, transparent fronts, fronts with graphics or any other form of visual cue for shoppers.

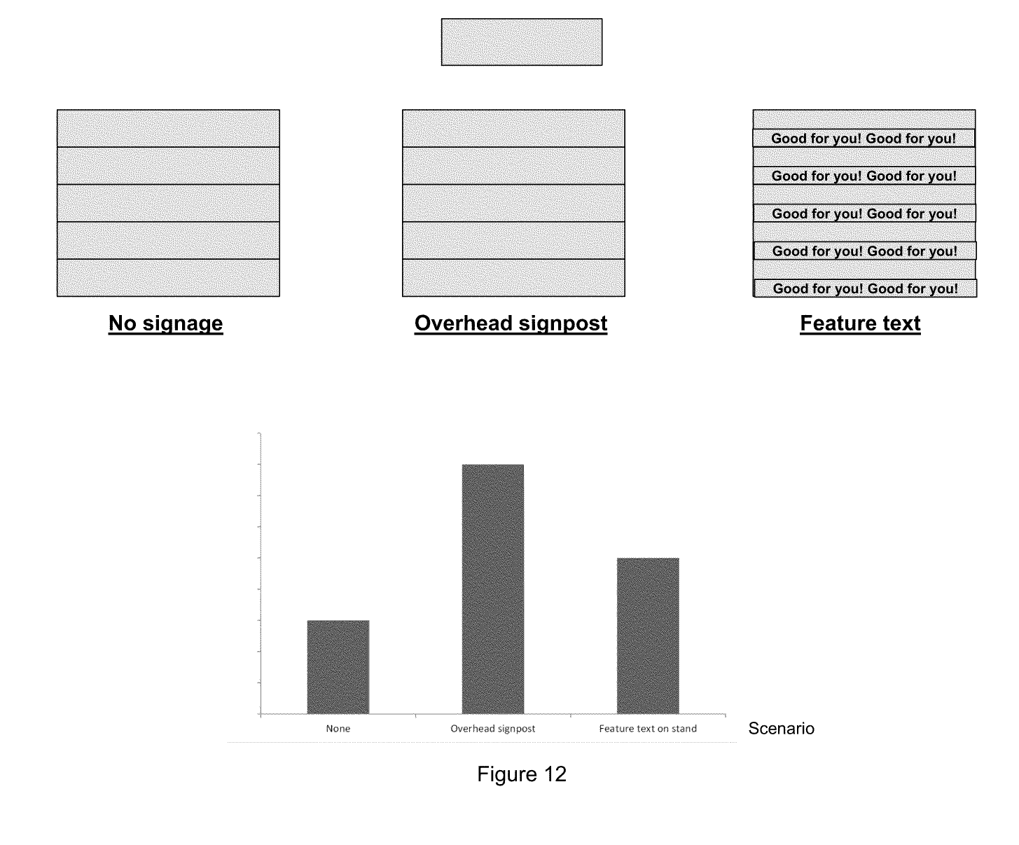

Some illustrative forms of the relationship between signage and F_{sg} are shown in FIG. 12. Some signage approaches have far greater impact than others on likelihood of shoppers shopping the display.

F_{sg} may be constructed as:

a single multiplier for the whole display;

a multiplier specific to a portion of display where a certain signage item is in place; or

a multiplier specific to certain items on the display affected by a signage item.

F_{sg} may be measured by testing different signage candidates in successive test cells vs. an unsigned control and measuring:

visibility Fᵥᵢₛ directly; or

conversion keeping all other factors constant;

Activation factor, F_{ac} is an index variable reflecting the impact on visibility of activated merchandising features, i.e. those that are electronically switchable on or off. Activated merchandising features may include full illumination of the display, illumination of a section of the display, audio messaging, shopper interaction, multimedia displays. Features may operate continuously or respond to shopper actions, for example motion sensors, pickup of certain items, interaction on a touch screen, scanning of a QR code.

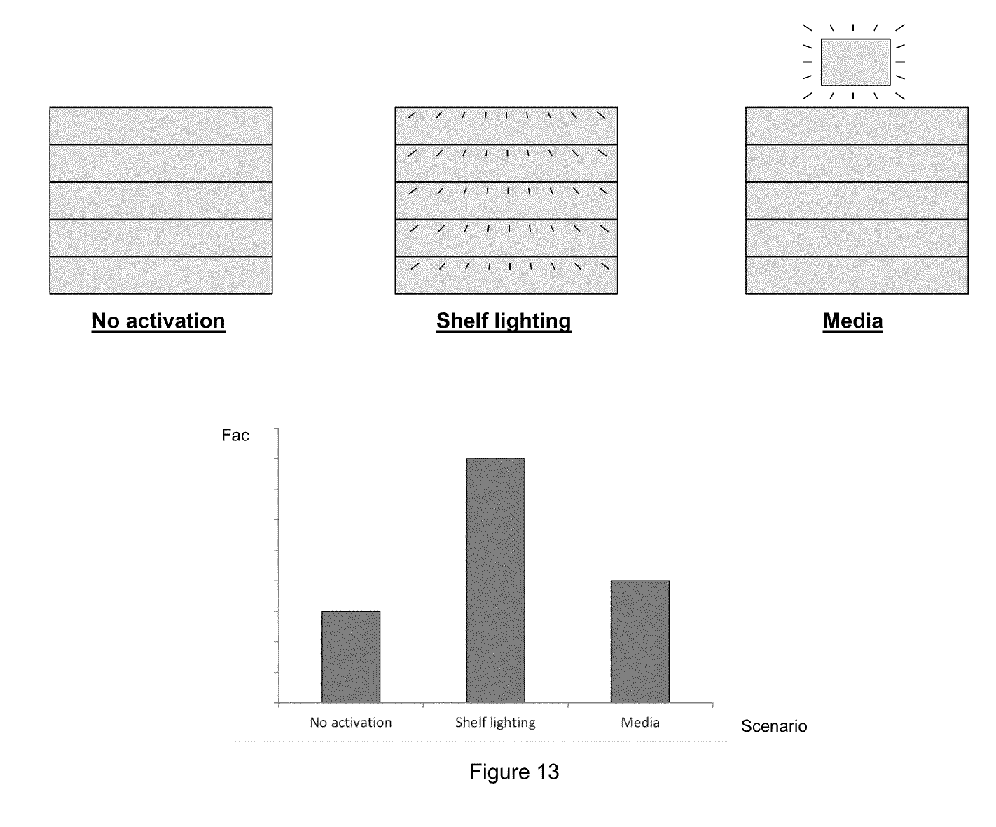

Some illustrative forms of the relationship between activation measures and F_{ac} are shown in FIG. 13. Some activation approaches have far greater impact than others on likelihood of shoppers visually shopping the display.

For modeling purposes F_{ac} may be constructed as:

a single multiplier for the whole display;

a multiplier specific to a portion of display; or

a multiplier specific to certain items on the display

F_{ac} may be measured by testing:

an activation candidate in a test cell vs. an unactivated control cell and measuring visibility factor Fᵥᵢₛ directly or conversion F_{conv} keeping all other factors constant or correcting for difference;

an activation candidate switched on for a period of time (typically one hour) and then off for a similar period, thus providing its own control with similar shopper traffic. This process eliminates any possible noise factors such as advertising, promotions.

Vertical exposure factor, Fᵥₑₓ is an index variable reflecting the impact of vertical visual angle of a product on visibility. Visual angle is the angle a viewed object subtends at the eye, usually stated in degrees of arc. It also is called the object's angular size. In our practical experience a greater vertical visual angle can significantly improve sales. In a retail context visual angle is determined by display design, often by raking or staggering tiers of product. Often a display designer must tradeoff visual angle vs. separation. Managed well, the net effect on sales can be quite considerable.

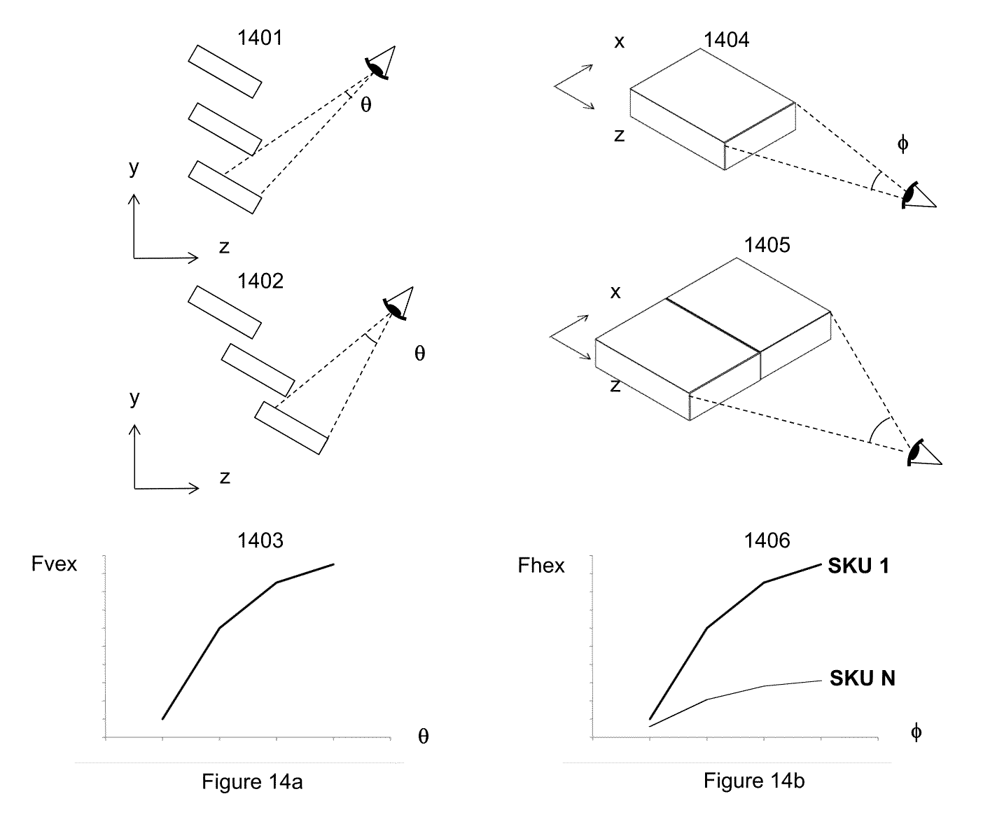

Typical forms of the relationships of Fᵥₑₓ and viewing angle are shown in FIG. 14a. In display 1401 consecutive shelves have been stacked immediately above each other, limiting the visual angle θ. In display 1402 consecutive shelves have been raked so at to increase the visual angle.

Graph 1403 shows an example effect of visual angle θ on Fᵥₑₓ, diminishing at higher θ as the field of view becomes saturated. For modeling purpose, Fᵥₑₓ may be constructed as:

a multiplier specific to a horizontal tier on the display when vertical angle is consistent across the tier; or

a multiplier specific to individual locations on the display when vertical angle is not consistent across the width of the display.

Horizontal Exposure factor, Fₕₑₓ is the horizontal analog of Vₕₑₓ. In our practical experience increasing horizontal visual angle can improve sales up to a limit. In a retail context horizontal visual angle is largely determined by planogram design, typically by multi-facing a product.

Typical forms of the relationships of Fₕₑₓ and viewing angle are shown in FIG. 14b. In display 1404 a single facing of product creates a horizontal visual angle φ. In display 1405 a double facing of product increases the visual angle φ Graph 1406 show an example effect of visual angle φ on Fᵥₑₓ, diminishing at higher φ as the field of view becomes saturated. Effectiveness of exposure generally shows diminishing returns. Our practical experience indicates that above a certain level of exposure there are diminishing returns beyond 10-15 degrees of arc, which we note roughly corresponds to the extent of the human macula which occupies 15 degrees field of view. Fₕₑₓ impact is typically greatest for top SKU #1, and less for lower ranking SKUs.

For modeling purposes, Fₕₑₓ may be constructed as a multiplier specific to a SKU dependent on number of facings and SKU ranking.

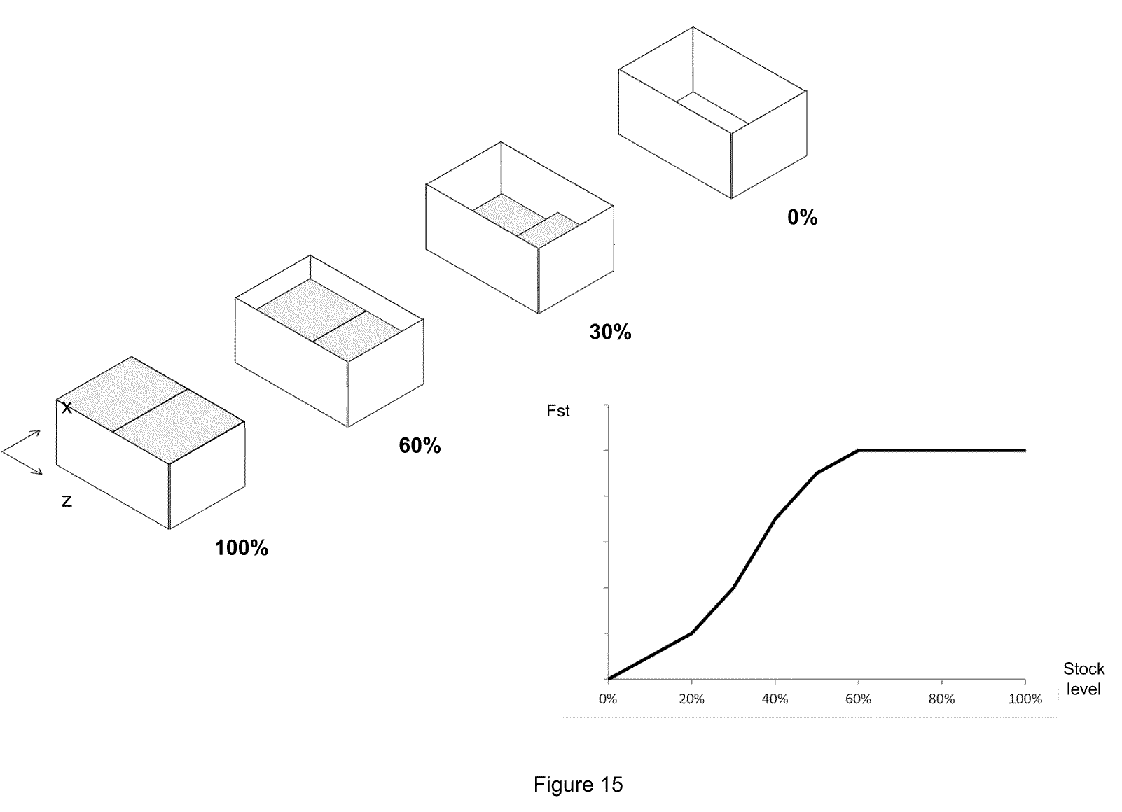

Stock-level factor, Fₛₜ, is an index variable reflecting the impact of stock levels of individual SKUs on the category. FIG. 15 illustrates a typical correspondence of stock level to Fₛₜ′.

fully out of stock by definition will reduce sales to zero;

however in our practical experience even approaching partial out of stocks also has an adverse effect because items lower in a carton are typically less visible, they are harder to extract and they are sometimes perceived to be less fresh;

In one embodiment for modeling purposes, Fₛₜ may be constructed as a multiplier for each individual SKU based on own stock level.

We note that often out-of-stock of top-selling SKUs has an adverse effect of other SKUs—these SKUs act as a banner for the category. In a further embodiment Fₛₜ may be expanded as follows:

Fₛₜ=F_{stb}×Fₛₜᵢ

### Where

F_{stb}=stock factor for top selling banner SKU
Fₛₜᵢ=stock factor for individual SKU

Fₛₜ functions may be best estimated by:

explicitly measuring stock levels over a long duration in real time and correlating impact on visibility and conversion at SKU level; or

artificially creating out of stocks on key items and correlating the impact on conversion and/or visibility.

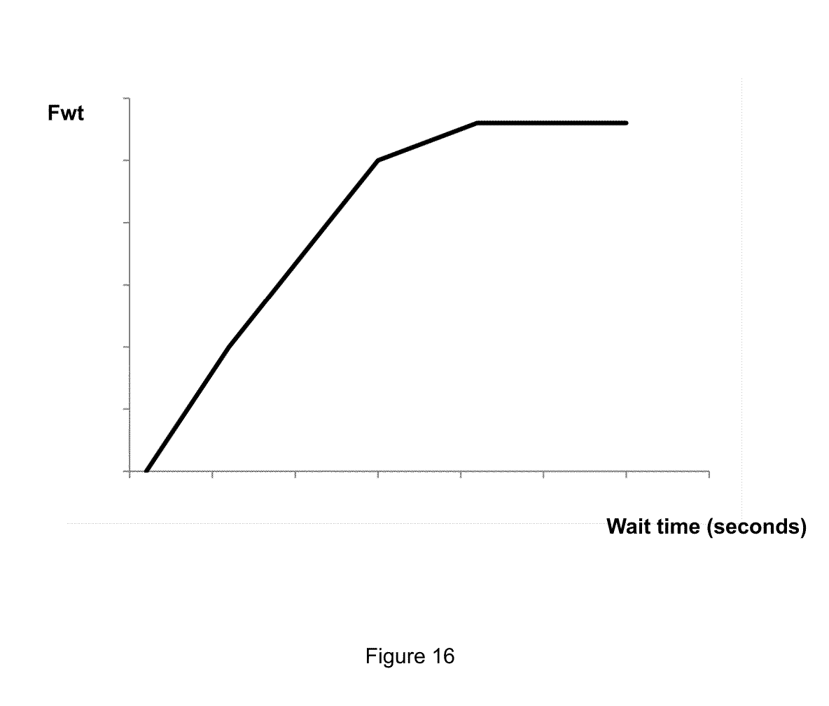

Wait-time factor, F_{wt} is an index variable reflecting the impact of wait time on the category. A typical relationship between wait time and F_{wt} is shown in FIG. 16. The longer a shopper is forced to wait in front of a display, the more he or she is likely to buy, ultimately reaching saturation with longer wait times.

For modeling purposes, F_{wt} may be constructed as a multiplier for the whole display. F_{wt} may be best estimated by explicitly measuring wait time by tracking shopper position in front of display and fitting and examining the impact on conversion.

Ergonomics and visibility may be combined to create a “heat-map”—a two-dimensional representation of the likelihood of a shopper to purchase based on ergonomics and visibility alone and independent of desirability of any product placed in that location.

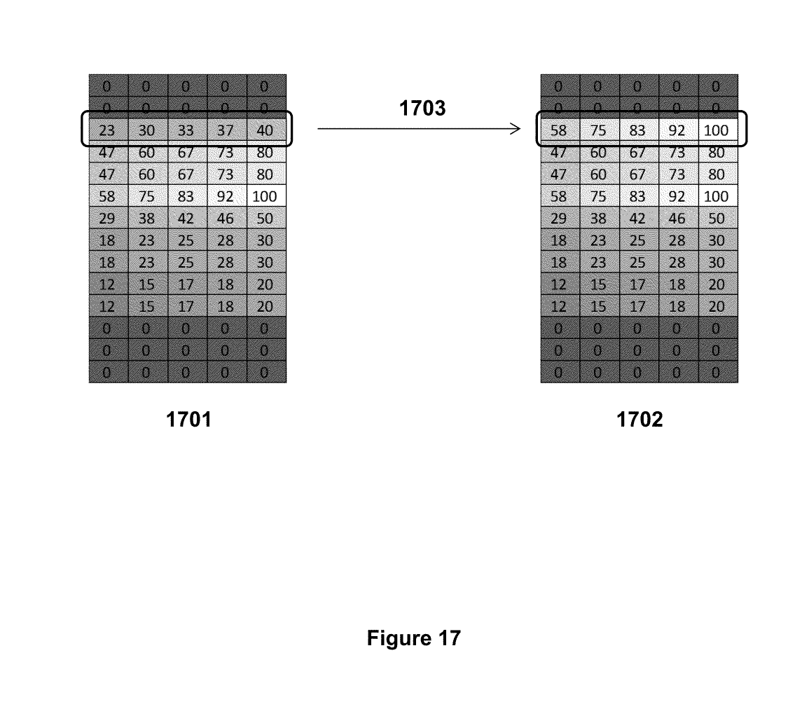

An example of heat-maps combining proximity and visibility effects is shown in FIG. 17. In 1701, all shelves of product are equally exposed. In 1702, top shelf of product Fᵥₑₓ has been increased by removing a cover over the top shelf. The net result is heat-map change 1703.

Desirability factor, F_{des} is an index variable reflecting the impact on conversion of the desirability of the product. F_{des} is influenced primarily by marketing choices. Most precisely, F_{des} is the fraction of shoppers fixating on the display that actually take away product

F_{des}=Fᵤₙ×F_{cd}×F_{adj}×Fₚᵣ×Fₛₚ×F_{cu}×Fₛₕ×Fₛₘ

Where

Fᵤₙ=unmodified conversion of SKU
F_{cd}=container design factor
F_{adj}=adjacency factor
Fₚᵣ=pricing factor
F_{adv}=advertising factor
Fₛₚ=salesperson interaction factor
F_{cu}=cue factor
Fₛₕ=shopper-graphics factor
Fₛₘ=shopper mission factor

Unmodified conversion of SKU, Fᵤₙ, is the unmodified demand and represents the intrinsic preference for the SKU. This is best estimated as a residual parameter after correcting for all other factors.

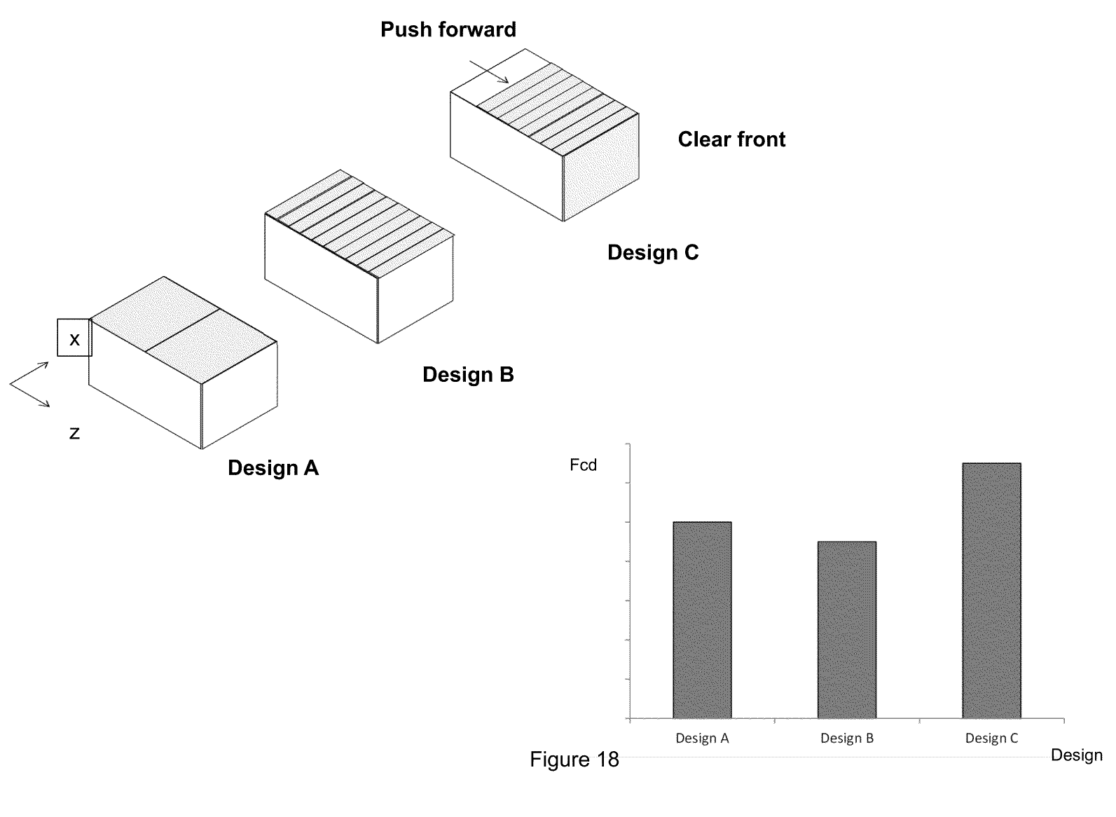

Container design factor, F_{cd}, represents the effect of container design. Other container designs may incorporate graphics that boost demand. Other container designs may make it physically less (or more) difficult to remove product from shelf. An example of the impact of container design on F_{cd} is shown in FIG. 18. In design A, product packs are stored horizontally in their inner carton to drive a “billboard” effect. In design B, packs are stored vertically for ease of removal. In design C, packs are stored vertically for ease of removal with also a pusher mechanism to ensure shoppers are always presented with product at a convenient reach.

For modeling purposes, F_{cd} is best represented as a factor specific to container design for a particular SKU.

An F_{cd} model may be best estimated by testing different container designs vs. a control and measuring SKU level conversion keeping all other factors constant.

Adjacency factor, F_{adj} represents the impact of placing specific SKUs adjacent to each other. In our practical experience, SKU placements can either a substitution (negative) or positive (halo) impact on sales of adjacent SKUs.

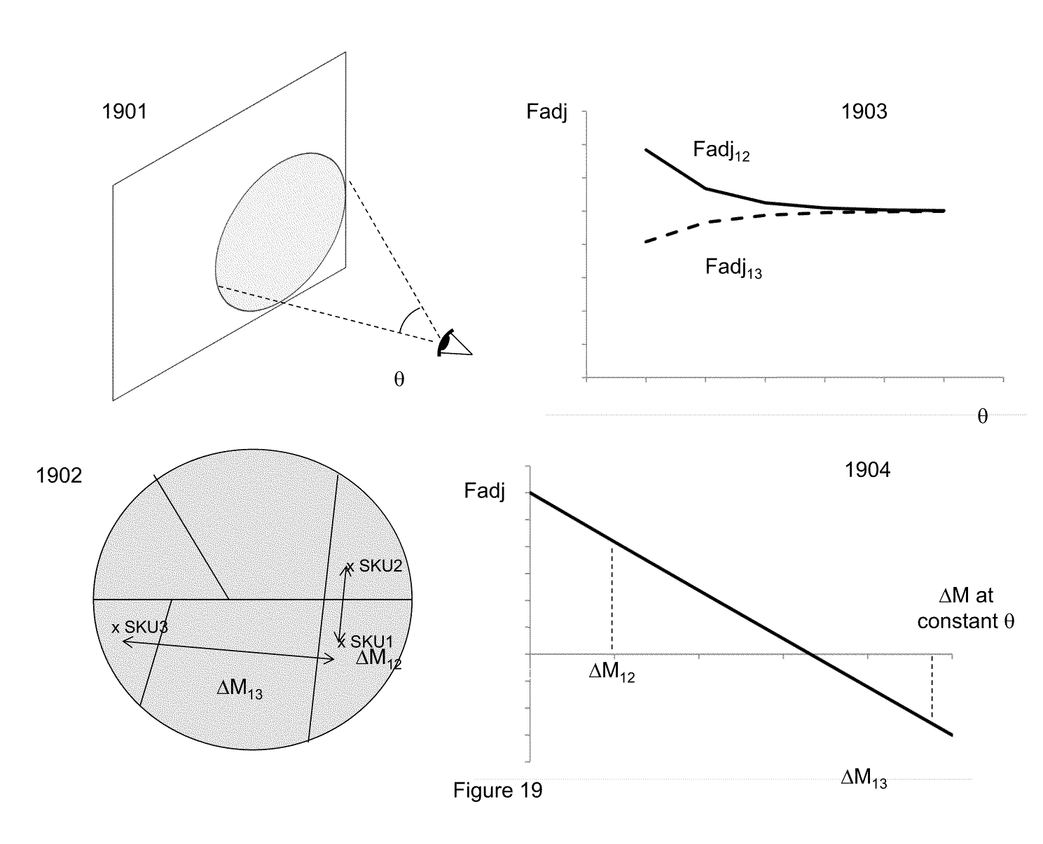

A practical model is shown in FIG. 19. Typically SKUs have ability to produce adjacency halo lift for an effective range within ˜an arc of 15 degrees, which we note again is approximately the size of the human macula. We also observe that the closer SKUs are together in consumers' mental maps, the more likely they are to be cross-shopped (for example see 1902 a cross-shopping chart—the closer SKUs on this diagram the more likely they are to be cross-shopped).

In 1903, SKUs 1 and 2 are shown to have a positive increase on sales of each other by positioning them adjacent; in the same graph SKUs 1 and 3 have a net negative effect. In 1904 is shown that above a certain separation in consumers' mental maps, SKUs cannibalize by being placed adjacent whereas SKUs closer together in mental space can drive lift.

F_{adj} may be best modeled as an array variable describing the interaction of any two SKUs. F_{adj} may be estimated by:

fit vs. cross shopping data of SKUs i and j from sources such as shopper panel data—the more likely SKUs are to get cross shopped, the more reinforcing they will be when placed adjacent on planogram adjacency;

examining cross-shopping of SKUs over time through shopper handling, for example a shopper picking up SKU i may often put SKU i back and pick up SKU j—depending on category anywhere from 10% to 50% of transactions involve some level of cross handling; or

planogram experiments;

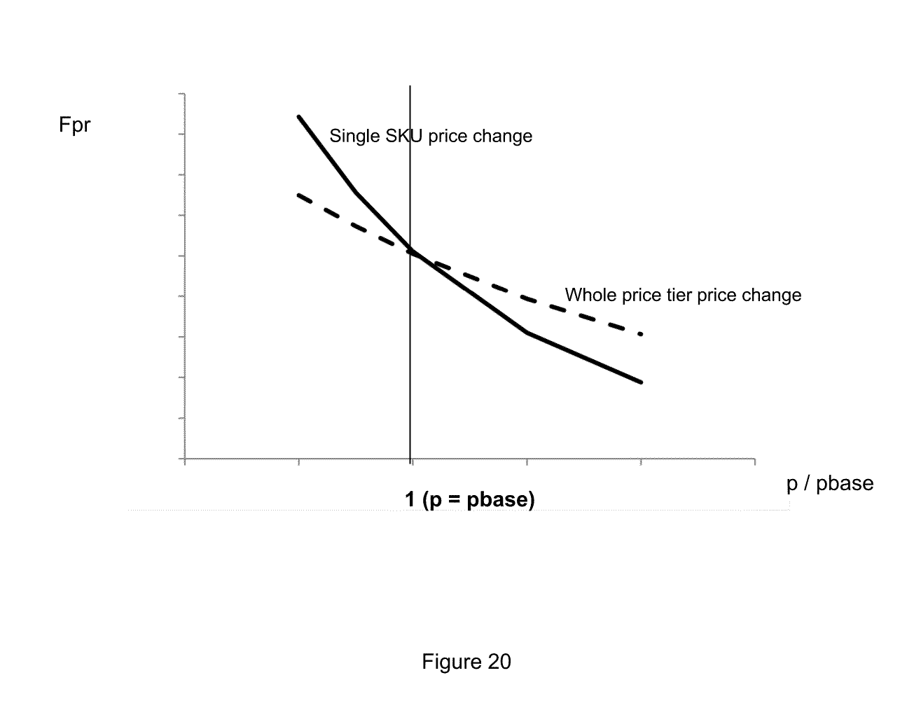

Pricing factor, Fₚᵣ, represents the effect of pricing on desirability. Typical forms of this relationship are shown in FIG. 20, each characterized by price elasticity.

For modeling purposes, Fₚᵣ may be modeled either at the SKU level of price tier level as:

a continuous elasticity curve;

a stepwise price elasticity curve with key psychological price points;

Elasticities may be estimated by:

specific price changes of individual SKUs; or

a designed experiment moving price tiers

Advertising and promotion factor, F_{adv}, represents the impact of advertising and promotion activities on desirability. As well documented, different media vehicles (for example TV, Print, Radio) produce differing levels of effectiveness. In our practical experience increasing investment typically shows diminishing returns and different campaigns can have significantly different levels of effectiveness.

For modeling purposes F_{adv} is best modeled as:

an effectiveness coefficient for a specific brand being promoted; and

a further coefficient for non-promoted brands which experience halo or substitution.

F_{adv} may be estimated through any type of econometrics time series model which are well known in the literature and typically include:

a fitted carryover function;

advertising investment (typically measured in “GRPs” or “TARPs”) in the local market;

a different model for each media vehicle;

an effectiveness coefficient for each media campaign

F_{adv} can also be estimated by single source data combining shopper panel data and media panel data

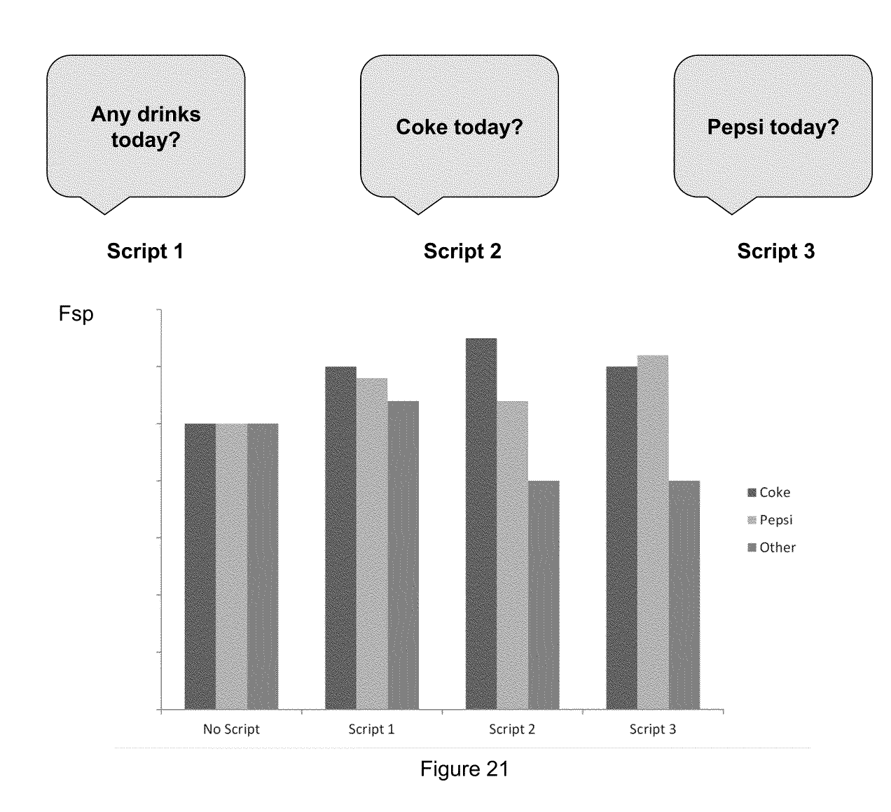

Salesperson interaction factor, Fₛₚ, represents the impact of salesperson interaction for a specific SKU. Interactions may take the form of a “till-point” conversation in the simplest form “how about some category X for you today”, but may range to extensive cross sell. Some examples of impact of sales pitch on different products are shown in FIG. 21

For modeling purposes Fₛₚ may be measured as:

an overall category factor for specific set of tactics;

SKU level factors for specific set of tactics

Fₛₚ is best modeled by consistently delivering a sales pitch vs. control and measuring impact on desirability or conversion.

Cue factor, F_{cu}, represents the impact of other shopper cues. In some circumstances, if shopper B witnesses shopper A pickup a product, shopper B has an increased likelihood to also pickup. This effect is particularly strong in close quarters such as checkout areas (less so in self scan checkouts). Retailers can actively manage this effect by engineering queuing arrangements so shoppers can witness each others' impulse behavior.

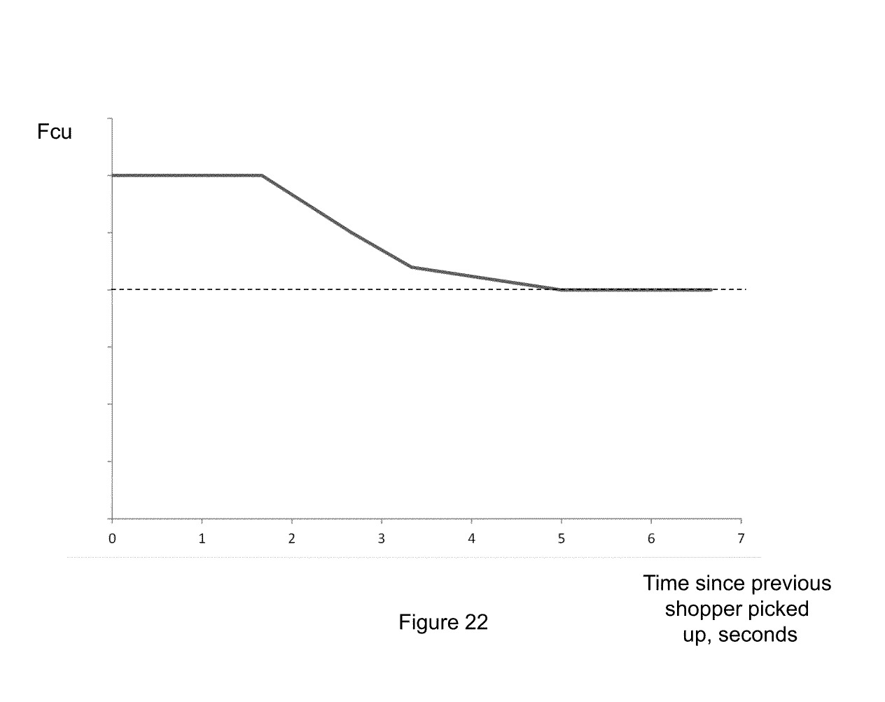

FIG. 22 shows a typical relationship between F_{cu} and time since prior purchase. For modeling purposes F_{cu} may be modeled as a single factor based on time since most recent pickup

F_{cu} may be estimated by examining time series conversion and proximity data, creating probability curves as a function of various time buckets since prior pickup.

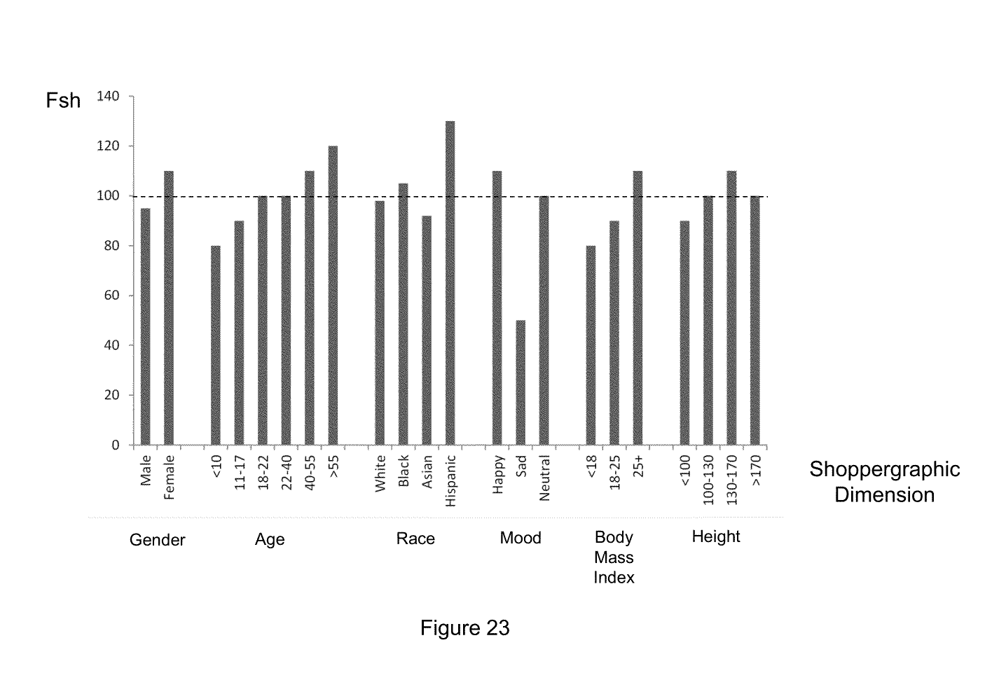

Shopper-graphics factor, Fₛₕ, represents the impact of measureable parameters of the shopper him/herself on desirability and conversion more generally and can include but not limited to do demographics, mood, physical parameters such as weight, height. FIG. 23 shows a typical example of the effect of shopper-graphics including age, gender, race, mood, attire, Body Mass Index and height.

For modeling purposes Fₛₕ is best modeled as a set of factors for a brand or category bucketed based on a shopper-graphic cut

Fₛₕ=F_{age}×F_{gen}×F_{mood}×Fₑₜₕ×Fₐₜₜ×F_{bmi}×Fₕₜ

### Where

F_{age}=age index representing impact of age bucket on likelihood to purchase
F_{gen}=gender index representing impact of gender on likelihood to purchase
F_{mood}=mood index representing impact of mood on likelihood to purchase
Fₑₜₕ=ethnicity index representing impact of ethnicity on likelihood to purchase
F_{bmi}=body mass index representing impact of body mass index on likelihood to purchase
Fₕₜ=shopper height index representing impact of shopper height on likelihood to purchase
Fₐₜₜ=attire index representing impact of attire on likelihood to purchase

Fₛₕ may be estimated by correlation of conversion with shopper-graphics from;

shopper camera at display; or

biometrics measurement—e.g. weight mat, height sensor.

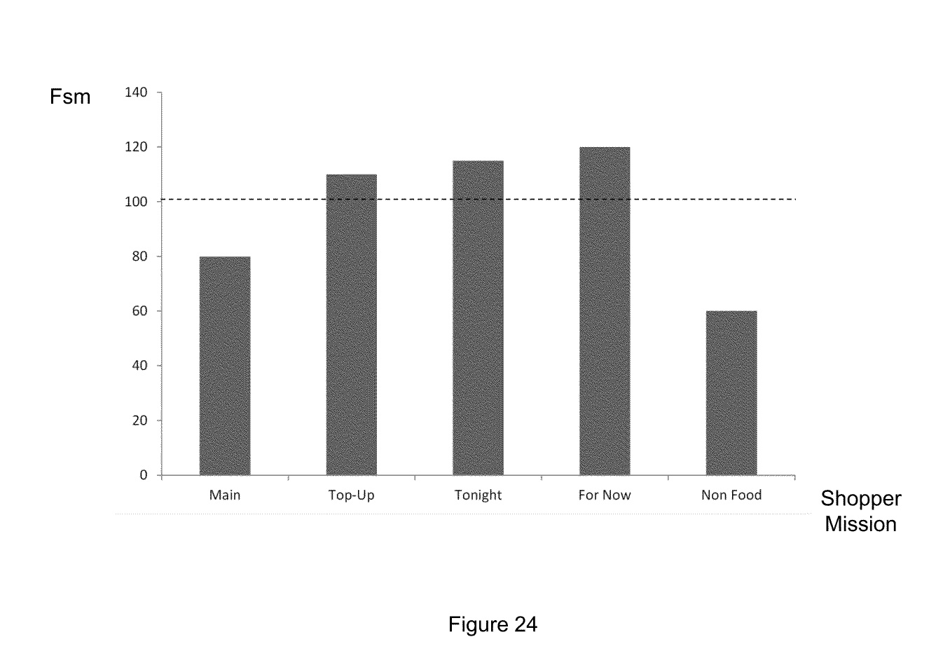

Shopper mission factor, Fₛₘ, represents the impact of the main purpose for the shopper's main visit to the store. FIG. 24 shows a typical profile for Fₛₘ. Fₛₘ may be modeled as a set of categorical factors representing typical mission buckets for example: “Main shop”, “Top-Up”, “Tonight”, “For Now” and “Non-Food”.

Fₛₘ is best estimated by categorizing visits based on till receipt data, basket size and time of day.

### Example of Process Used to Establish a Heat-Map for F_{Erg}

1. Identify that five cells needed (baseline plus four scenarios) to separate Fₓ, F_{y} keeping F_{z} constant
2. Complete Baseline
3. Move all shelves up one
4. Move all shelves up two
5. Move planogram left by one third
6. Move planogram right by one third
7. Install each test cell in sequence and validate installation
8. Measure pickups, shopper time in position, shopper traffic
9. Calculate real time metrics—penetration, motion sensors blocked
10. Generate data quality report—if any data quality issues, initiate corrective actions
11. When converged at >2000 valid shopper events move on to next test cell
12. When all test cells have been completed fit Fₓ and F_{y} to the form of equations above.
13. Create model learnings report—heat-map of F_{erg} as function of x and y
14. Update parameters in simulator
15. Run optimizer to optimized planogram around heat-map

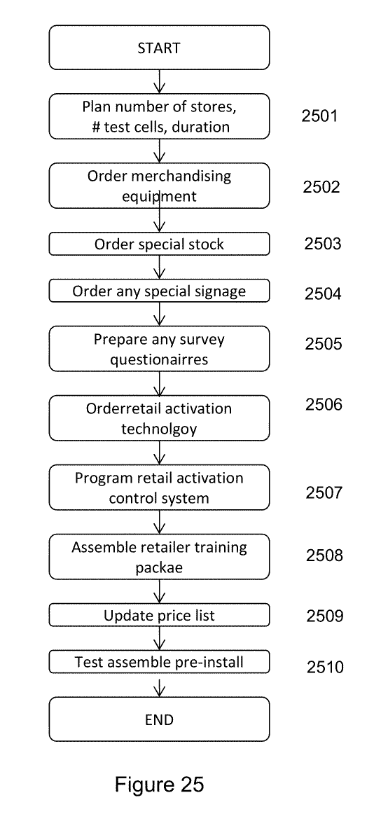

FIG. 25 demonstrates a flow chart for planning a set of test cells. While it is possible to execute this manually, this set of tasks benefits greatly from automation—either through an expert system, a project management tool, or an Enterprise Resource System. A number of test cells are identified 2501 based on experimental objectives. Orders are placed for any required merchandising equipment 2502, special stock 2503, and signage 2504 for the test cells. If shopper intercepts will be conducted, questionnaires are prepared 2505. Any activation technology 2506 is ordered and any programming (e.g. on/off schedule) is programmed 2507. Any retailer training materials are prepared 2508, price lists are updated 2509 and any required test equipment tested prior to installation in store.

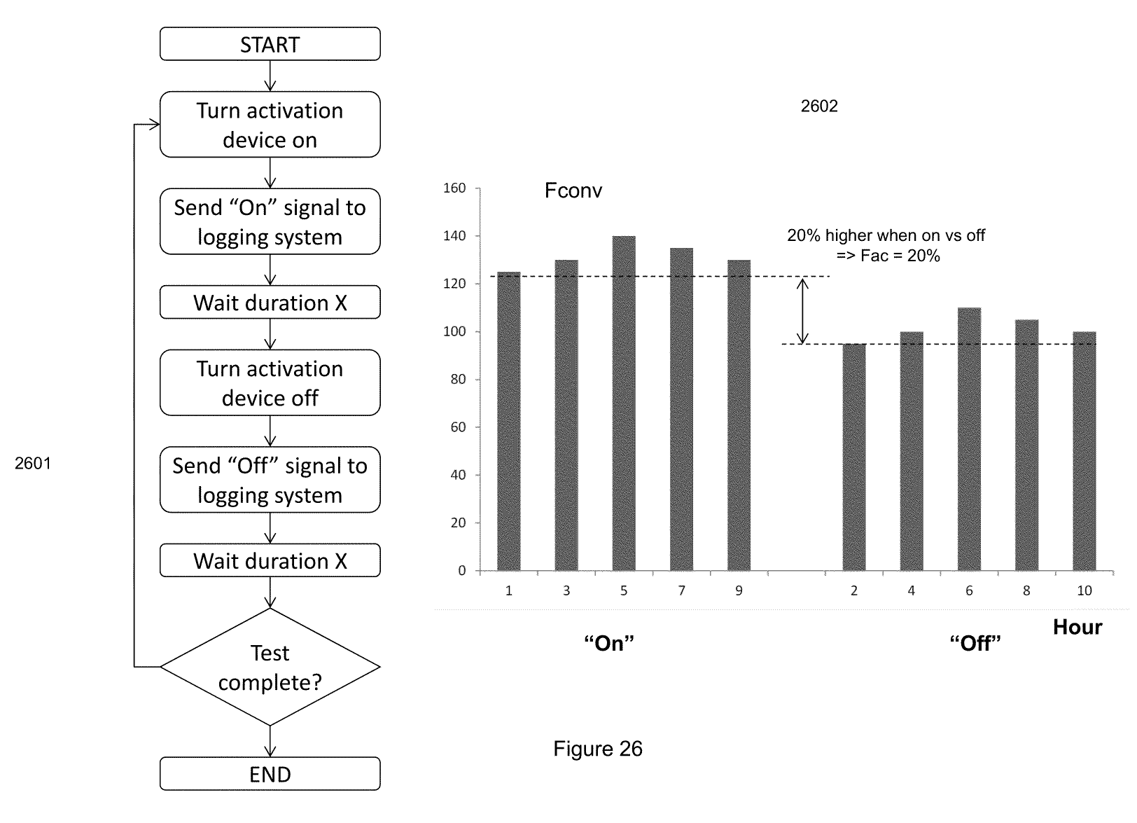

FIG. 26 demonstrates how the sales maximization system can be applied to measure F_{ac}. Activation device is turned on and then system waits for a designated period X, typically one hour. Then the activation device is turned off for a corresponding period. This continues until the test cell is completed. Sample output is shown 2602—conversion is plotted for adjacent on-off periods Medians are taken across all “on” cells and all “off” cell and Fac may be calculated.

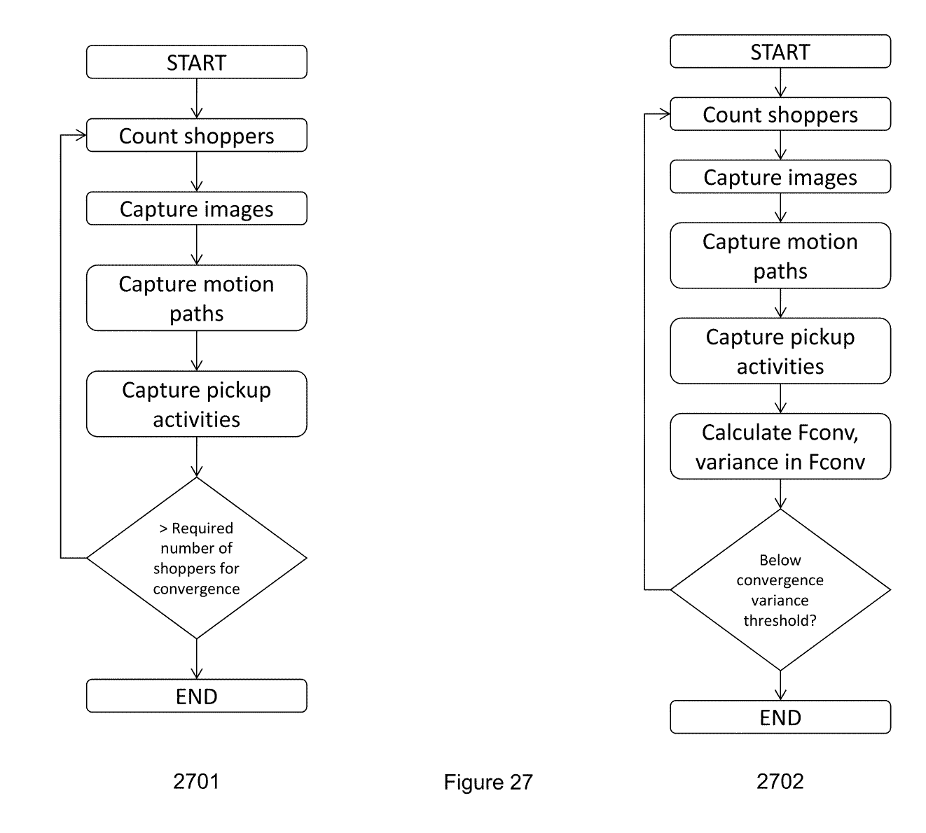

FIG. 27 illustrates two possible approaches to determining convergence of a test cell. 2701 illustrates a method using a convergence specified by a certain number of shoppers 2702 illustrates a more rigorous method measuring actual variance in conversion numbers and waiting for this to fall below a specific cutoff.

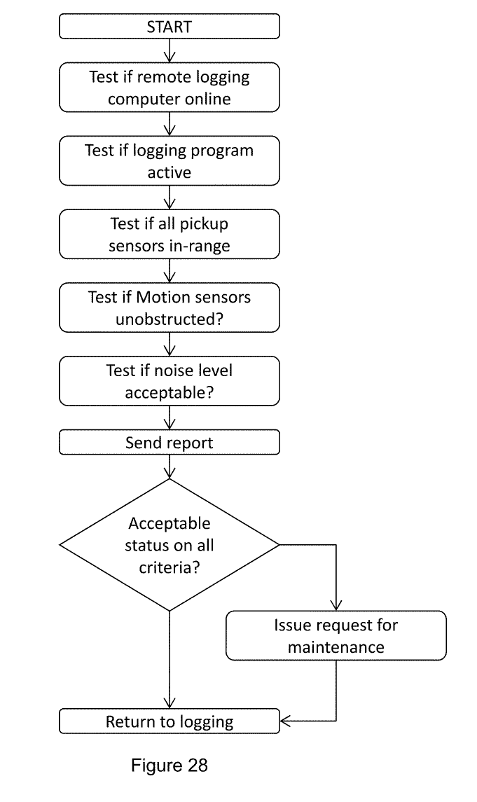

Uptime of in-store logging systems is a key performance requirement of the sales maximization system. FIG. 28 illustrates onboard quality control of data as conducted on logging computer. The computer screens for proper functionality of the logging program, all pickup sensors in operational range, motion sensors unobstructed and acceptable level of noise. If any of these tests fail a request for maintenance is issued.

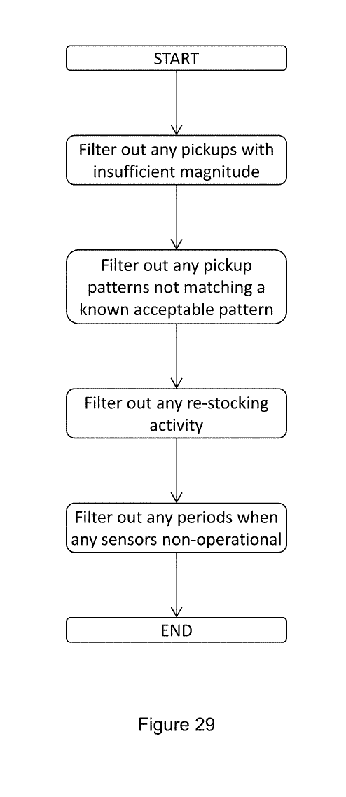

FIG. 29 illustrates a procedure for data cleaning. Any pickups that were lighter than a configurable threshold are screened out and likewise any pickups not matching a typical pickup force profile. Any re-stocking periods are filtered out as are any periods when one or more sensors were non-operational.

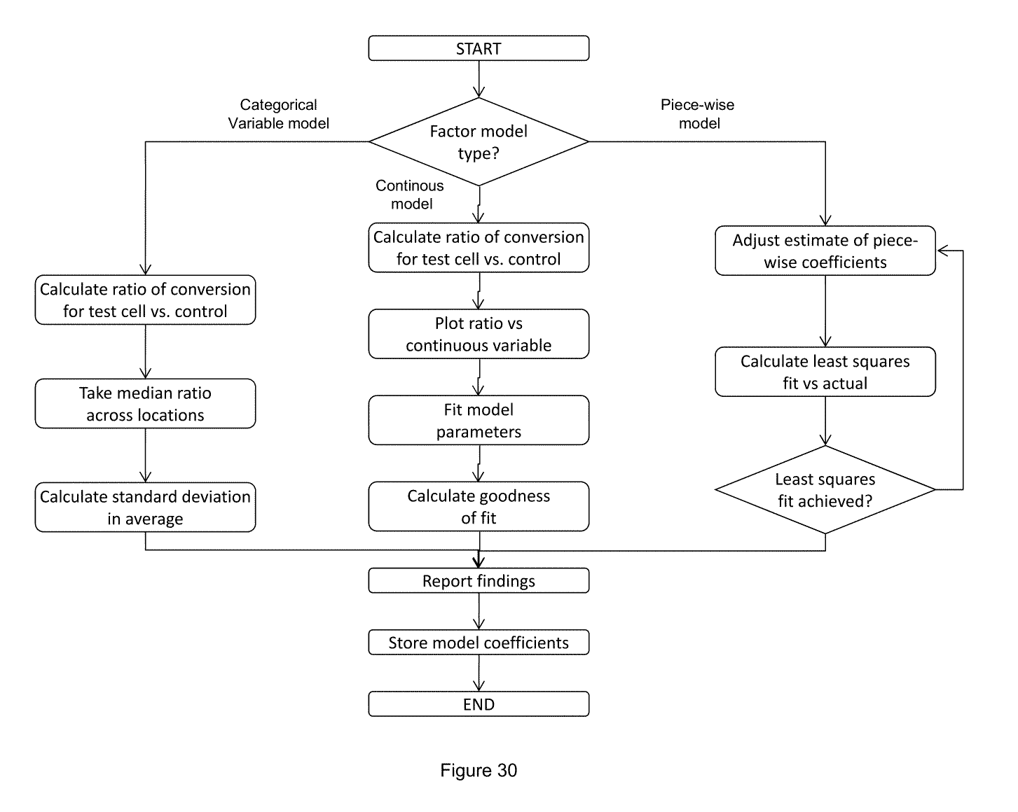

FIG. 30 illustrates a procedure for model fitting. A different approach is required for three different classes of model factor:

Categorical Variable model (in the current embodiment including F_{cd}, F_{ac}, Fₛₚ, Fₛₕ, Fₛₘ;

Continuous model (in the current embodiment including F_{sz}, Fᵥₑₓ, Fₕₑₓ, Fₛₜ, F_{wt}, F_{adj}, Fₚᵣ, F_{cu}, F_{adv}); or

Piece-wise model (in the current embodiment including Fₓ, F_{y}, F_{z})

Categorical variables are fitted by calculating test cell conversion vs. control and then taking the median across all locations, testing standard deviation for sufficient consistency.

Continuous variables are fitted by calculating test cell conversion vs. control and then plotting results against the continuous variable of interest. A model is fitted and goodness of fit estimated by R²; R² is then evaluated for sufficient goodness of fit.

Piece-wise models are modeled by creating an array of values for each x, y, and z position, modeling the impact and then calculating sum square deviation vs. actual. An optimizer is used to drive the array values to least squares fit.

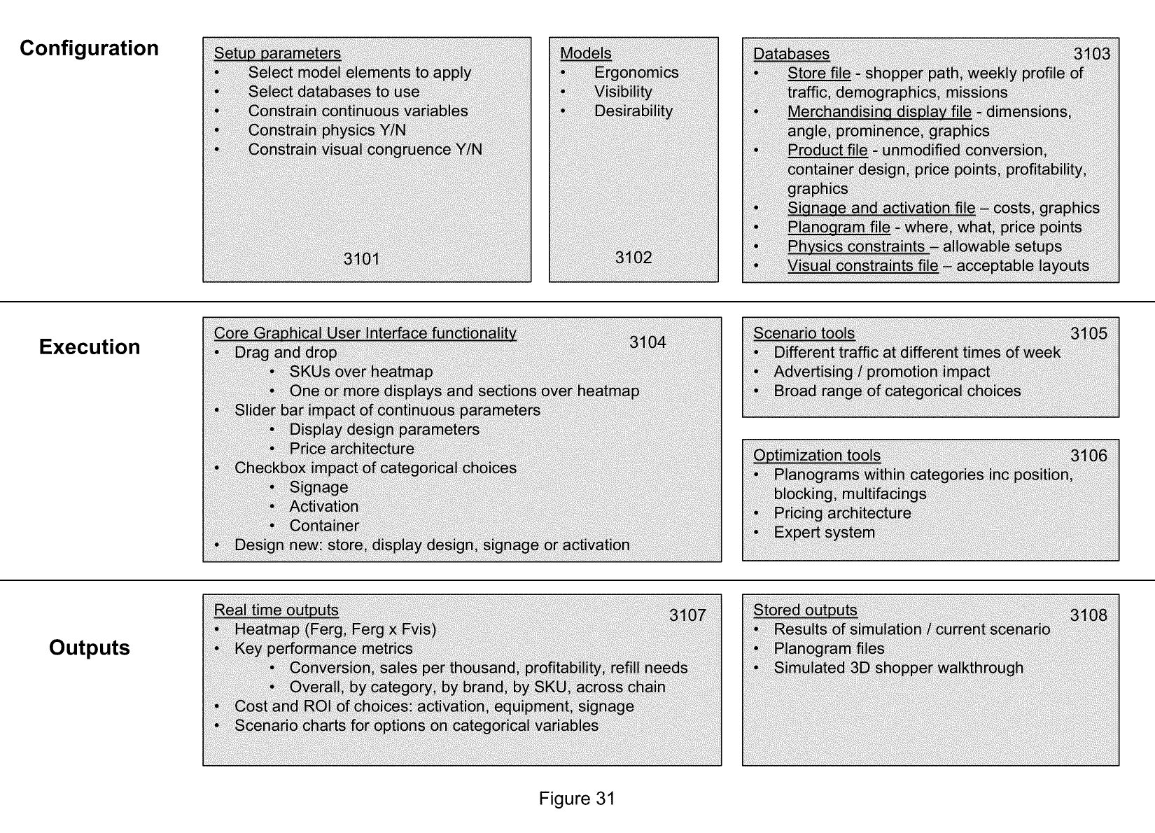

In some embodiments, simulation and optimization may be carried out using a graphical user interface. FIG. 31 illustrates a specification for a graphical user interface (GUI) for the purposes of simulation and optimizing sales using the constructed model.

The user begins by configuring a set of setup parameters 3101, models 3102 and databases 3103. Setup parameters 3101 include selection of which model elements to apply for example selecting from a list of available elements with checkboxes. The user may to use only a partial subset of elements, or all elements. The user may also select from a set of alternate databases. The user may set constraints on continuous variables, for example maximum and minimum pricing. The user may also choose to apply a set of physics constraints and visual constraints.

The physics constraint file contains a set of rules to avoid impossible or dangerous planograms or merchandising designs. Situations protected against would include for example:

setting shelves too close together; or

building an unstable display that can topple over.

The visual constraints file contains a set of heuristics to avoid aesthetically displeasing planograms. Situations protected against would include for example:

brand fragmentation to different corners of planogram; or

fragmentation of pack types to different corners of planogram.

Models 3102 include all fitted parameters resulting from the FIG. 30. Because of the multiplicative form of the model, it is possible to combine model elements from different sources. For example it would be possible to accurately combine merchandising activation test results from Australia with heat-map data from the U.S.A to simulate a completely new combination of layout and activation

Databases 3103 include:

a database of store files containing the relevant parts of store including physical layout of key elements such as checkouts, normal shopper path, weekly profile of traffic, shopper-graphic mix, mission mix, number of stores this represents, current category size;

a database of merchandising display files containing the characteristics of currently available merchandising displays, including dimensions, shelf angles, vertical exposures and graphics. The user may add additional display fields over time;

a database of product files listing characteristics of available products in the range including unmodified conversion, container design, price points, price elasticities, profitability, graphics, cross-shopping metrics vs. other key SKUs, advertising and promotional responsiveness;

a database of signage and activation files listing characteristics of a set of signage and activation options including uplifts, costs, graphics; and a database of planogram files containing product placement on standard planograms

The user may add to additional files to these databases either within the package or third party applications such as Solidworks, AutoCAD, Google Sketch.

The core graphical user interface 3104, includes the ability to:

drag and drop SKUs to any location on planogram;

drag and drop merchandising displays to any valid location in physical space;

adjust display design with slider bars;

adjust pricing architecture with slider bars;

choose categorical options with checkboxes: signage, activation options, container design;

create a new store layout, display design, signage or activation; and

generate likely shopper path and hotspots given floorplan and unknown hotspot pattern.

Scenario tools 3105 include the ability to run scenarios for any variables in the model, including but not limited to:

different traffic levels at different times of week;

advertising/promotion impact; or

options on categorical choices.

Optimization tools 3106 include the ability to optimize any variables in the model, including but not limited to:

a planogram;

planograms within subcategories including position, blocking, multifacings; or

pricing architecture.

Simulated annealing algorithms are particularly suitable for optimization in this context given the large number of levels at which factors can potentially interact.

An expert system may be used to identify key possibilities to improve by identifying gaps to best in class.

As the user manipulates the GUI they are presented with a number of real time outputs 3107 including but not limited to:

heat-map (either modeled only with F_{erg}, F_{erg}×Fᵥᵢₛ or both simultaneously);

key performance metrics including F_{erg}, Fᵥᵢₛ, F_{des}, F_{conv}, sales per thousand shoppers, profitability, refill needs with configurable drilldown to show these for category, by brand, by SKU; and

cost and ROI of choices: activation, equipment, signage, retailer incentives; and

scenario charts for options on categorical variables.

The simulation tool is also capable of producing a number of stored outputs 3107 on request by the user including but not limited to:

store results of simulation/current scenario;

store current planograms; or

store current arrangement in form for a visualization tool.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for optimizing productivity of a merchandizing space, the method comprising:
placing a configuration of products within a defined merchandizing area;
tracking, using an array of sensors, individual shopper interactions with the products within the merchandizing area;
tracking, using an array of sensors, shopper proximity and motion paths within the merchandizing area;
tracking, using an array of sensors or proxies, shopper visibility of product items within the merchandising area;
logging shopper interactions, shopper proximity and shopper visibility as tracked by the sensors;
varying, within the predefined merchandizing area, one or more of aspects associated with the products or interaction with the shoppers;
repeating the tracking and logging;
fitting the shopper interactions to a model of product conversion; and
simulating possible scenarios for physical layout and product placement using the fitted model and outputting, for each simulation, an indication of shopper conversion associated with the simulation.

2. The method of claim 1 wherein varying one or more aspects associated with the products or interaction with the shoppers includes varying one or more of: configuration of products, layout of the merchandising area, queuing arrangements within the merchandising area, position and/or orientation of display unit, design of display unit, vertical or horizontal exposure of a part of the display unit, signage associated with merchandising area, activation methods used in the merchandising area, the stock level on the display unit, the mix of SKUs placed on the display unit, the design of product packaging or containers, and pricing or products displayed, sales person interactions with shoppers.

3. The method of claim 1 wherein placing a configuration of products within a merchandizing area includes placing a test cell comprising a plurality of rows and columns of products in a retail establishment.

4. The method of claim 1 wherein tracking the individual shopper interactions includes using weight sensors to monitor shopper removal of products.

5. The method of claim 1 wherein tracking the individual shopper interactions includes using optical sensors to monitor shopper removal of products.

6. The method of claim 1 wherein tracking the individual shopper interactions includes using checkout transaction logs to monitor shopper removal of products.

7. The method of claim 1 wherein tracking shopper proximity and motion paths includes using position and range sensors.

8. The method of claim 1 wherein tracking individual shopper interactions includes using one or more cameras.

9. The method of claim 1 wherein tracking shopper proximity and motion paths includes using one or more cameras.

10. The method of claim 1 comprising providing software for controlling activation activities in the merchandizing space.

11. The method of claim 10 wherein the activation activities include at least one of activation of a product display, media presentation, and audio presentation.

12. The method of claim 1 wherein fitting the shopper interactions to a model of product conversion includes determining, based on the shopper interactions, model factors relating to ergonomics, visibility, and product desirability.

13. The method of claim 12 wherein the model factors relating to ergonomics includes at least one of: a horizontal factor, a vertical factor, and a separation factor.

14. The method of claim 12 wherein the model factors relating to product visibility include at least one of: a size factor, a signage factor, an activation factor, a vertical exposure factor, a horizontal exposure factor, a stock level factor, and a wait time factor.

15. The method of claim 12 wherein the model factors relating to desirability include at least one of: an unmodified conversion of SKU factor, a container design factor, an adjacency factor, a pricing factor, an advertising factor, a salesperson interaction factor, a cue factor, a shopper-graphics factor, and a shopper mission factor.

16. The method of claim 1 comprising outputting a planogram indicating an optimized configuration of the products.

17. The method of claim 1 wherein the model of product conversion includes a heat-map of conversion.

18. The method of claim 1 comprising providing a graphical user interface (GUI) for invoking the simulation and optimizing sales of the products.

19. The method of claim 1 comprising measuring any combination of:
waiting time of shoppers in the merchandising area; advertising or promotions associated with products in the merchandising area; active or passive interactions between shoppers; shopper mission; or shopper-graphics including age, gender, race, mood, physical characteristics, attire.

20. The method of claim 1 wherein tracking shopper visibility includes using a gaze tracking system, an eye tracking system, or one or more cameras.

21. A system for optimizing productivity of a merchandizing space, the system comprising:
a first array of sensors configured to track individual shopper interactions with the products in a configuration of products within a merchandizing area;
a second array of sensors configured to track shopper proximity and motion paths within the merchandizing area;
a third array of sensors or proxies configured to track shopper visibility within the merchandizing area;
a logging module configured to log shopper interactions and shopper proximity and motion paths tracked by the sensors, wherein when one or more aspects associated with the products or interaction with the shoppers are varied, the first, second and third arrays of sensors are configured to repeat the tracking and the logging module is configured to repeat the logging,
a predictive and analytics module configured to fit the shopper interactions to a model of product conversion, to simulate possible product placement scenarios using the fitted model and to output, for each simulation, an indication of shopper conversion associated with the simulation.

22. The system of claim 21 wherein the logging module is configured to log shopper analytics, motion paths and visibility for variations in configuration of products, layout of the merchandising area, queuing arrangements within the merchandising area, position and/or orientation of display unit, design of display unit, vertical or horizontal exposure of a part of the display unit, signage associated with merchandising area, activation methods used in the merchandising area, the stock level on the display unit, the mix of SKUs placed on the display unit, the design of product packaging or containers, and pricing or products displayed, sales person interactions with shoppers.

23. The system of claim 21 wherein the configuration of products comprises a test cell comprising a plurality of rows and columns of products in a retail establishment.

24. The system of claim 21 wherein the first array of sensors includes weight sensors configured to monitor shopper removal of products.

25. The system of claim 21 wherein the first array of sensors includes optical sensors configured to monitor shopper removal of products.

26. The system of claim 21 wherein the logging module is configured to use checkout transaction logs to monitor shopper removal of products.

27. The system of claim 21 wherein the second array of sensors includes position and range sensors configured to track shopper proximity and motion paths.

28. The system of claim 21 wherein the first array of sensors includes at least one camera configured to track shopper interactions with the products.

29. The system of claim 21 wherein the second array of sensors includes at least one camera configured to track shopper proximity and motion paths

30. The system of claim 21 comprising a controller configured to control activation activities in the merchandizing space.

31. The system of claim 30 wherein the activation activities include at least one of illumination of a product display, media presentation, and audio presentation.

32. The system of claim 21 wherein the predictive analytics module is configured to fit the shopper interactions to a model of product conversion by determining, based on the shopper interactions, model factors relating to ergonomics, visibility, and product desirability.

33. The system of claim 32 wherein the model factors relating to ergonomics includes at least one of: a horizontal factor, a vertical factor, and a separation factor.

34. The system of claim 32 wherein the model factors relating to product visibility include at least one of: a size factor, a signage factor, an activation factor, a vertical exposure factor, a horizontal exposure factor, a stock level factor, and a wait time factor.

35. The system of claim 32 wherein the model factors relating to desirability include at least one of: an unmodified SKU conversion factor, a container design factor, an adjacency factor, a pricing factor, an advertising factor, a salesperson interaction factor, a cue factor, a shopper graphics factor, and a shopper mission factor.

36. The system of claim 21 wherein the predictive and analytics module is configured to output a planogram indicating an optimized configuration of the products.

37. The system of claim 21 wherein the model of product conversion includes a heat-map of product of conversion.

38. The system of claim 21 comprising a graphical user interface (GUI) configured to invoke the simulation and optimize sales of the products.

39. The system of claim 21 comprising measuring any combination of: waiting time of shoppers in the merchandising area; advertising or promotions associated with products in the merchandising area; active or passive interactions between shoppers; shopper mission; or shopper-graphics including age, gender, race, mood, physical characteristics, attire.

40. A non-transitory computer readable medium having stored therein executable instructions that when executed by the processor of a computer control the computer to perform steps comprising:
tracking, using a first array of sensors, individual shopper interactions with the products in a configuration of products within a merchandizing area;
tracking, using a second array of sensors, shopper proximity and motion paths within the merchandizing area;
tracking, using a third array of sensors or proxies, shopper visibility within the merchandizing area;
logging shopper interactions and shopper proximity and motion paths tracked by the sensors;
varying, within the predefined merchandizing area, one or more of aspects associated with the products or interaction with the shoppers; repeating the tracking and logging;
fitting the shopper interactions to a model of product conversion; and
simulating possible product placement scenarios using the fitted model and outputting, for each simulation, an indication of shopper conversion associated with the simulation.
